(19) United States
(12) Patent Application Publication
(10) Pub. No.: US 2016/0116911 A1
(43) Pub. Date: Apr. 28, 2016

(54) ASSEMBLY ORDER GENERATION DEVICE AND ASSEMBLY ORDER GENERATION METHOD

(71) Applicant: HITACHI, LTD., Tokyo (JP)

(72) Inventors: Noriaki YAMAMOTO, Tokyo (JP); Hirofumi TAGUCHI, Tokyo (JP); Atsuko ENOMOTO, Tokyo (JP)

(21) Appl. No.: 14/896,803

(22) PCT Filed: Jun. 12, 2013
(86) PCT No.: PCT/JP2013/066196

§ 371 Date: Dec. 8, 2015

(51) Int. Cl. G05B 19/418; G06F 17/30

(52) U.S. Cl. CPC G05B 19/41805; G06F 17/30958; G05B 2219/31066

(57) ABSTRACT

An assembly order generation device includes a radial/axial direction component detector which detects a component existing in a radial direction of a featured shape and a component existing in an axial direction of the component in a 3D CAD model. A directed graph expresses a connection precedence relationship in which the component is depicted by a node and a connection precedence relationship between the components which is depicted by a directed edge based on the detection result. A unit of disassembling and a disassembling order proposal based on the connection precedence relationship is generated, and an assembling order/direction/motion generation unit generates a disassemble direction based on the unit of disassembling and the disassembling order proposal and an assembly graph to generate a disassembling direction and a disassembling order, and reversely converts the generated disassembling direction and the generated disassembling order to derive an assembling order and an assembling direction.

### TECHNICAL FIELD

The present invention relates to an assembly order generation device and an assembly order generation method.

### BACKGROUND ART

As a background art in this technical field, there is Japanese Patent Publication No. 3689226 (Patent Document 1). The publication discloses a configuration which includes an interference calculation means for performing a calculation including a minimum approach distance and a determination on interference between a component in the middle of disassembling and remaining components in a state of being disassembled, and a disassembling path search means for searching a disassembling path avoiding interference between the components while making the interference calculation means perform the calculation.

In addition, there is a Japanese Patent Publication No. 3705672 (Patent Document 2). The publication discloses a configuration which includes a means for inputting CAD data to which information of connection information between the components necessary in an assembling work plan, a subassembly to be generated, an assembling order of the components, a robot, and a jig is added, a means for describing the connection information in a unit of component by a liaison graph of each axial direction with respect to the components necessary for assembling a product based on the CAD data, and a means for generating an assembling order Petri net based on the liaison graph, a target component of the jig, and a constraint condition.

In addition, there is a Japanese Patent Publication No. 5121266 (Patent Document 3). The publication discloses a configuration of an assembling order deriving process which includes a contact relationship data acquisition means for acquiring contact relationship data containing whether the components come in contact with each other in a state of a finished product, and an arrangement order of the components in the whole finished product from a state where the respective components are arranged in a line on an assembly axis.

### RELATED ART DOCUMENTS

### Patent Documents

Patent Document 1: Japanese Patent Publication No. 3689226

Patent Document 2: Japanese Patent Publication No. 3705672

Patent Document 3: Japanese Patent Publication No. 5121266

### SUMMARY OF THE INVENTION

### Problems to be Solved by the Invention

The inventor has reviewed the technologies disclosed in Patent Documents 1 to 3, and as a result found out the following. In the Patent Document 1, an interference calculation is necessarily performed in the middle of disassembling in order to search the disassembling path. In the Patent Document 2, the connection information between the components and an assembling order of the components unnecessary in the assembling work plan are necessarily added to the CAD data. In the Patent Document 3, it is necessary to read the contact relationship data which contains the contact between the components and the order thereof in a state where the finished product is composed.

Therefore, the present invention has been made to solve the above problems, and a representative object thereof is to provide an assembly order generation technology to automatically calculate an assembling order at a design stage. More specifically, an assembly order generation device and an assembly order generation method are provided in which a connection precedence relationship between the components is automatically calculated in a state of the finished product not in the middle of disassembling based on a three-dimensional assembly model (3D CAD model), an assembling order proposal is derived based on the relationship diagram, and a workability is evaluated based on the assembling order proposal, so that the assembling order is automatically calculated at the design stage.

Other objects and novel features besides the above descriptions of the present invention will be apparent through the explanation and the accompanying drawings of this specification.

### Means for Solving the Problems

The followings are the outlines of representative inventions in the inventions disclosed in the present application.

(1) A representative assembly order generation device is a generation device that generates information of an assembling order for assembling a plurality of components composing an assembly using a computer. The assembly order generation device includes an information acquisition unit that extracts information of component attribute, a component arrangement, and an adjacency relationship with respect to the other components of each of the plurality of components from a 3D CAD model of the assembly acquired from of a CAD, a component type classifying unit that classifies a component type based on the information of the 3D CAD model, and a featured shape detection unit that detects a designated featured shape from the 3D CAD model. The assembly order generation device further includes a component detection unit that detects a component existing in a radial direction of the featured shape detected by the featured shape detection unit and a component existing in an axial direction of the subject component in the 3D CAD model, a directed graph generation unit that expresses a connection precedence relationship by a directed graph in which the component is depicted by a node and a connection precedence relationship between the components is depicted by a directed edge based on a detection result of the component detection unit, and a disassembling order proposal generation unit that generates a unit of disassembling and a disassembling order proposal based on the connection precedence relationship of the directed graph generation unit. The assembly order generation device further includes an assembly graph generation unit that expresses a relationship between the components by an assembly graph in which the component is depicted by a node and an adjacency relationship is depicted by an edge based on information of an adjacency relationship between the components of the 3D CAD model and an assembling order generation unit that generates a disassemble direction based on the unit of disassembling and the disassembling order proposal generated by the disassembling order proposal generation unit and the assembly graph of the assembly graph generation unit to generate a disassembling direction and a disassembling order, and reversely converts the generated disassembling direction and the generated disassembling order to derive an assembling order and an assembling direction.

(2) A representative assembly order generation method is a generation method of generating information of an assembling order for assembling a plurality of components composing an assembly using a computer. The assembly order generation method, as process steps performed by the computer, includes an information acquisition step of extracting information of a component attribute, a component arrangement, and an adjacency relationship with respect to the other components of each of the plurality of components from a 3D CAD model of the assembly acquired from a CAD, a component type classification step of classifying a component type based on the information of the 3D CAD model, and a featured shape detection step of detecting a designated featured shape from the 3D CAD model. The assembly order generation method further includes a component detection step of detecting a component existing in a radial direction of the featured shape detected in the featured shape detection step and a component existing in an axial direction of the subject component in the 3D CAD model, a directed graph generation step of expressing a connection precedence relationship by a directed graph in which the component is depicted by a node and a connection precedence relationship between the components is depicted by a directed edge based on a detection result of the component detection step, and a disassembling order proposal generation step of generating a unit of disassembling and a disassembling order proposal based on the connection precedence relationship of the directed graph generation step. The assembly order generation method further includes an assembly graph generation step of expressing a relationship between the components by an assembly graph in which the component is depicted by the node and an adjacency relationship is depicted by an edge based on information of an adjacency relationship between the components of the 3D CAD model, and an assembling order generation step of generating a disassemble direction based on the unit of disassembling and the disassembling order proposal generated in the disassembling order proposal generation step and the assembly graph of the assembly graph generation step to generate a disassembling direction and a disassembling order, and of reversely converting the generated disassembling direction and the generated disassembling order to derive an assembling order and an assembling direction.

### Effects of the Invention

The effects achieved by the representative inventions in the inventions disclosed in the present application can be simply explained as follows.

That is, a representative effect is to provide an assembly order generation technology to automatically calculate an assembling order at a design stage. More specifically, an assembly order generation device and an assembly order generation method can be provided in which a connection precedence relationship between the components is automatically calculated in a state of the finished product not in the middle of disassembling based on a three-dimensional assembly model (3D CAD model), an assembling order proposal is derived based on the relationship diagram, and a workability is evaluated based on the assembling order proposal, so that the assembling order is automatically calculated at the design stage.

### BRIEF DESCRIPTIONS OF THE DRAWINGS

FIG. 1 is a diagram schematically illustrating the exemplary entire configuration of an assembly order generation device according to an embodiment of the present invention;

FIG. 2 is a flowchart for describing an example of a procedure from a process of generating an assembling order and an assembling process based on 3D CAD data to a process of outputting an assembly sequence calculating result in an assembly order generation method in the assembly order generation device of FIG. 1;

FIG. 3 is a diagram illustrating an exemplary table of 3D CAD model information stored in a storage unit of the assembly order generation device of FIG. 1;

FIG. 4 is a diagram illustrating an exemplary table of component type information stored in the storage unit of the assembly order generation device of FIG. 1;

FIG. 5 is a diagram illustrating an exemplary result obtained when a cylindrical hole, a partial cylinder, and a circular ring are detected from an assembly model in the assembly order generation method of FIG. 2;

FIG. 6 is a diagram illustrating an example of a component and an output distance of the component detected by operating a light beam in a radial direction of a cylindrical hole in the assembly order generation method of FIG. 2;

FIG. 7 is a diagram illustrating an exemplary calculation result of a vector from the center to the gravity center of a fastening component in the assembly order generation method of FIG. 2;

FIG. 8 is a diagram for describing a method of detecting an obstacle component in a light beam scan of an axial direction of a disassembling direction of the fastening component in the assembly order generation method of FIG. 2, in which (a) illustrates an assembled state, (b) illustrates a state where a fastening portion is loosened, and (c) illustrates a state where the fastening component is fallen out;

FIG. 9 is a diagram illustrating an exemplary output obtained as a result of the light beam scan in the disassembling direction (the axial direction) of the fastening component in the assembly order generation method of FIG. 2;

FIG. 10 is a diagram for describing an example of a connection precedence relationship list (a) and a directed graph of a connection precedence relationship (b) obtained as a result of the light beam scan in FIG. 8;

FIG. 11 is a diagram for describing an example of a 3D CAD assembly model in the assembly order generation method of FIG. 2;

FIG. 12 is a diagram for describing an example of a connection precedence relationship directed graph of the assembly model of FIG. 11;

FIG. 13 is a diagram for describing an example of the connection precedence relationship directed graph in which components of the same name and of the same assembling direction are integrated with respect to FIG. 12;

FIG. 14 is a diagram illustrating an exemplary state in which the fastening components (501 to 503) in FIG. 13 are disassembled;

FIG. 15 is a diagram illustrating an exemplary assembling process which is generated from the connection precedence relationship directed graph of FIG. 13;

FIG. 16 is a diagram illustrating an exemplary calculation of the number of inward/outward arrows generated in the assembling process with respect to FIG. 13;

FIG. 17 is a diagram illustrating an example in which the assembling process is derived based on the number of inward/outward arrows of FIG. 16;

FIG. 18 is a diagram for describing an example of the derived assembling process of FIG. 17;

FIG. 19 is a diagram illustrating an example in which the assembling process is derived in consideration of an order of obstacle components detected at the time of disassembling in FIG. 17;

FIG. 20 is a diagram for describing an example of the derived assembling process of FIG. 19;

FIG. 21 is a diagram for describing an example of an individually-defined determination rule of the assembling process in the assembly order generation method of FIG. 2;

FIG. 22 is a diagram illustrating an exemplary assembly graph in the assembly order generation method of FIG. 2; and

FIG. 23 is a flowchart for describing an exemplary procedure of processing deduction of a disassembling order and a disassembling motion and a conversion into an assembling order and an assembling motion in the assembly order generation method of FIG. 2.

### DETAILED DESCRIPTION OF PREFERRED EMBODIMENTS

In the following, the description will be made by being divided into a plurality of sections or embodiments as needed for the convenience sake. These sections or embodiments are related to each other (if not elsewhere particularly specified), and one portion may be related to a modification, a detailed description, or a supplement description of a part or all of the other portions. In addition, in the following embodiments, in a case where the numbers (including number, numerical value, quantity, range, etc.) of elements are given, the invention is not limited to the specified numbers except a case where it is not elsewhere particularly specified or it is apparent that the numbers are limited to specified numbers in principle, and the numbers maybe equal to or more than or less than the specified numbers.

Furthermore, in the following embodiments, it is a matter of course that the components (including element steps etc.) are not necessarily essential except a case where it is not elsewhere specified and it is considered as a dispensable essence in principle. Similarly, in the following embodiments, when a shape or a positional relation of the components is referred, substantially approximate or similar ones are included except a case where it is not elsewhere specified or it is considered that the shape or the positional relation is apparent in principle. This assumption is also applied to the numerical values and the ranges.

### Outline of Embodiments

First, the outline of embodiments will be described. In the outline of the embodiments, the description will be made by attaching components or symbols in parentheses corresponding to those of the embodiments as an example.

(1) A representative assembly order generation device of this embodiment is a generation device which generates information of an assembling order for assembling a plurality of components composing an assembly using a computer. The assembly order generation device includes an information acquisition unit (a 3D CAD model information acquisition unit 111) which extracts information of a component attribute, a component arrangement, and an adjacency relationship with respect to the other components of each of the plurality of components from a 3D CAD model of the assembly acquired from a CAD, a component type classifying unit (a component type classifying unit 112) which classifies a component type based on the information of the 3D CAD model, and a featured shape detection unit (a featured shape detection unit 113) which detects a designated featured shape from the 3D CAD model. Further, the assembly order generation device includes a component detection unit (a radial/axial direction component detection unit 121) which detects a component existing in a radial direction of the featured shape detected by the featured shape detection unit and a component existing in an axial direction of the subject component in the 3D CAD model, a directed graph generation unit (a directed graph generation unit 122) which expresses a connection precedence relationship by a directed graph in which the component is depicted by a node and a connection precedence relationship between the components is depicted by a directed edge based on a detection result of the component detection unit, and a disassembling order proposal generation unit (a disassembling order proposal generation unit 123) which generates a unit of disassembling and a disassembling order proposal based on the connection precedence relationship of the directed graph generation unit. Furthermore, the assembly order generation device includes an assembly graph generation unit (an assembly graph generation unit 114) which expresses a relationship between the components by an assembly graph in which the component is depicted by the node and an adjacency relationship is depicted by an edge based on information of an adjacency relationship between the components of the 3D CAD model, and an assembling order generation unit (an assembling order/direction/motion generation unit 115) which generates a disassemble direction based on the unit of disassembling and the disassembling order proposal generated by the disassembling order proposal generation unit and the assembly graph of the assembly graph generation unit to generate a disassembling direction and a disassembling order, and reversely converts the generated disassembling direction and the generated disassembling order to derive an assembling order and an assembling direction.

(2) A representative assembly order generation method of this embodiment is a generation method of generating information of an assembling order for assembling a plurality of components composing an assembly using a computer. The assembly order generation method, as process steps performed by the computer, includes an information acquisition step (S10) of extracting information of a component attribute, a component arrangement, and an adjacency relationship with respect to the other components of each of the plurality of components from a 3D CAD model of the assembly acquired from a CAD, a component type classification step (S20) of classifying a component type based on the information of the 3D CAD model, and a featured shape detection step (S30) of detecting a designated featured shape from the 3D CAD model. Further, the assembly order generation method includes a component detection step (S40, S50) of detecting a component existing in a radial direction of the featured shape detected in the featured shape detection step and a component existing in an axial direction of the subject component in the 3D CAD model, a directed graph generation step (S60) of expressing a connection precedence relationship by a directed graph in which the component is depicted by a node and a connection precedence relationship between the components is depicted by a directed edge based on a detection result of the component detection step, and a disassembling order proposal generation step (S70) of generating a unit of disassembling and a disassembling order proposal based on the connection precedence relationship of the directed graph generation step. Furthermore, the assembly order generation method includes an assembly graph generation step (S80, S90) of expressing a relationship between the components by an assembly graph in which the component is depicted by the node and an adjacency relationship is depicted by an edge based on information of an adjacency relationship between the components of the 3D CAD model, and an assembling order generation step (S100) of generating a disassemble direction based on the unit of disassembling and the disassembling order proposal generated in the disassembling order proposal generation step and the assembly graph of the assembly graph generation step to generate a disassembling direction and a disassembling order, and of reversely converting the generated disassembling direction and the generated disassembling order to derive an assembling order and an assembling direction.

Hereinafter, the embodiments based on the above outline will be described in detail with reference to the drawings. Further, the same members in all the drawings for describing the embodiments will be denoted by the same symbol in principle, and the description thereof will not be repeated.

### EMBODIMENTS

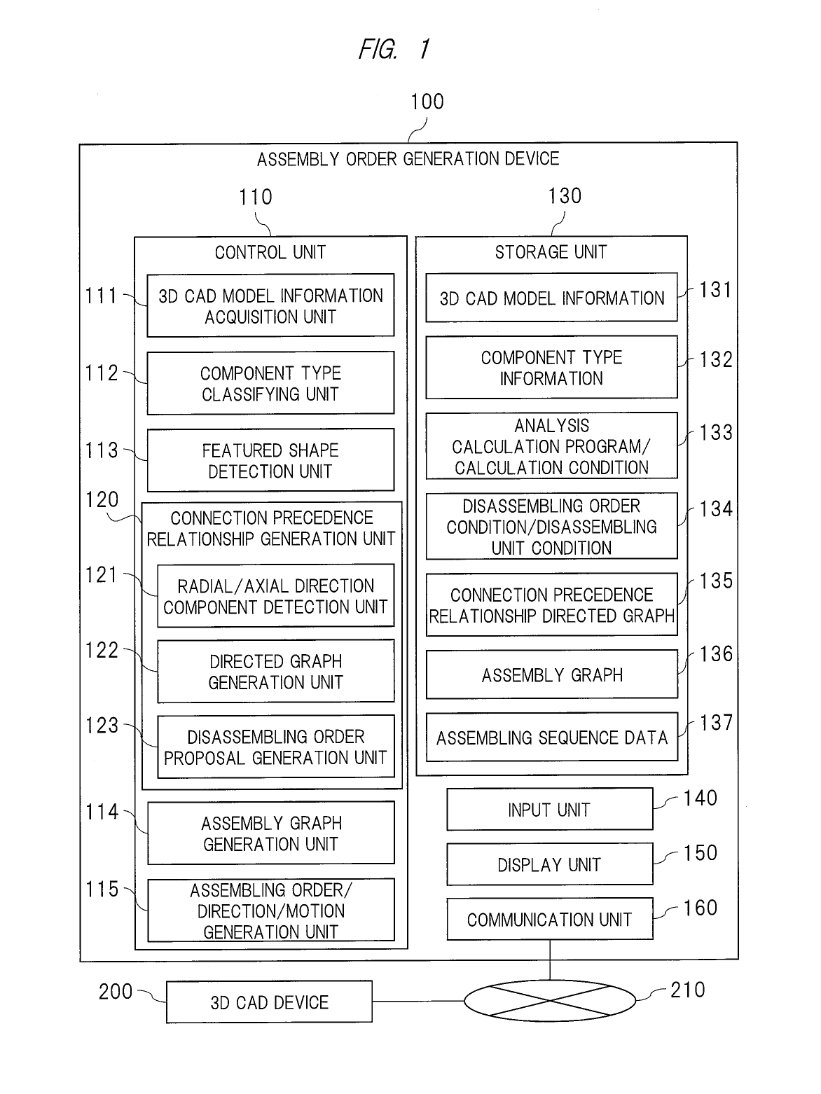

An assembly order generation device and an assembly order generation method according to the embodiment will be described using FIGS. 1 to 23.

In this embodiment, the description will be made about an example of an assembly order generation device (100) which classifies a component type, detects a featured shape, generates a connection precedence relationship and an assembly graph indicating an adjacency relationship between components, and generates an assembling order, an assembling direction, and a motion based on 3D CAD data of a product designed in a 3D CAD device (200).

### Configuration of Assembly Order Generation Device

First, the configuration of the assembly order generation device according to this embodiment will be described using FIG. 1. FIG. 1 is a diagram schematically illustrating the exemplary entire configuration of an assembly order generation device 100 according to this embodiment.

The assembly order generation device 100 according to this embodiment is established by a computer system, and includes a control unit 110, a storage unit 130, an input unit 140, a display unit 150, and a communication unit 160. The assembly order generation device 100 is connected to the 3D CAD device 200 in the outside from the communication unit 160 through a network 210.

The control unit 110 is a control unit which classifies the component type, detects the featured shape, generates the connection precedence relationship, generates the assembly graph, generates the assembling order/direction/motion, and outputs the result based on the 3D CAD data. The storage unit 130 is a storage unit which stores the 3D CAD data, an analysis calculation program, a calculation condition, and a calculation result. The input unit 140 is an input unit through which setting information necessary for the analysis is input, and an instruction to select a menu or other instructions are input. The display unit 150 is a display unit which displays an evaluation target model, input information, a processing result, and a procedure in the middle of processing. The communication unit 160 is a communication unit which receives the 3D CAD data from the 3D CAD device 200 in the outside through the network 210.

A hardware configuration of the assembly order generation device 100 is not limited to the above configuration, and may be as follows for example. The control unit 110 is configured to include a CPU (central processing unit, a ROM (read only memory), and a RAM (random access). The storage unit 130 is configured by an external storage device such as a hard disk device. For example, the input unit 140 includes a keyboard and a mouse. Besides, a touch panel, a dedicated switch, a sensor, or a speech recognition device may be employed. For example, the display unit 150 is configured by a device which displays information on a screen such as a display, a projector, or a head mounted display. Furthermore, a printer (not illustrated) may be connected to the assembly order generation device 100 to print the information displayed in the display unit 150 onto a sheet.

Further, these hardware configurations do not need to be dedicated devices, and for example a computer system such as a personal computer may be used.

The control unit 110 of the assembly order generation device 100 includes respective functional parts of a 3D CAD model information acquisition unit 111, a component type classifying unit 112, a featured shape detection unit 113, an assembly graph generation unit 114, an assembling order/direction/motion generation unit 115, and a connection precedence relationship generation unit 120. In addition, the connection precedence relationship generation unit 120 includes a radial/axial direction component detection unit 121, a directed graph generation unit 122, and a disassembling order proposal generation unit 123.

These respective functional parts 111 to 115, and 120 (121 to 123) included in the control unit 110 are realized by a program which is stored in the storage device and executed by the CPU in the control unit 110. That is, these respective functional parts are functions to be established in terms of software.

The 3D CAD model information acquisition unit 111 a functional unit which acquires information on a 3D CAD model. For example, the 3D CAD model information acquisition unit 111 performs a process of extracting information of a component attribute, a component arrangement, and an adjacency relationship with respect to the other components of each of a plurality of components from the 3D CAD model of an assembly acquired from the CAD.

The component type classifying unit 112 is a functional unit which classifies the component type. For example, the component type classifying unit 112 performs a process of classifying the component type based on the information of the 3D CAD model.

The featured shape detection unit 113 is a functional unit which detects the featured shape. For example, the featured shape detection unit 113 performs a process of detecting the designated featured shape from the 3D CAD model.

The assembly graph generation unit 114 is a functional unit which generates the assembly graph. For example, the assembly graph generation unit 114 performs a process of displaying a relationship between the components based on the information of the adjacency relationship between the components of the 3D CAD model by the assembly graph in which the component is depicted by a node and the adjacency relationship is depicted as an edge.

The assembling order/direction/motion generation unit 115 is a functional unit which generates an assembling order, an assembling direction, and a motion. For example, the assembling order/direction/motion generation unit 115 performs a process of generating a disassemble direction to generate a disassembling direction and a disassembling order based on a unit of disassembling and a disassembling order proposal generated by the disassembling order proposal generation unit 123 and the assembly graph of the assembly graph generation unit 114, and deriving an assembling order and an assembling direction by reversely converting the disassembling direction and the disassembling order thus generated.

The connection precedence relationship generation unit 120 is a functional unit which derives a connection relationship between the components and generates the connection precedence relationship.

The radial/axial direction component detection unit 121 is a functional unit which detects a component existing in a radial direction of the featured shape (a cylindrical hole, etc.) and a component existing in an axial direction of the detected component. For example, the radial/axial direction component detection unit 121 performs a process of detecting the component existing in the radial direction of the featured shape detected by the featured shape detection unit 113 and the component existing in the axial direction of the detected component in the 3D CAD model.

The directed graph generation unit 122 is a functional unit which generates the directed graph of the connection precedence relationship. For example, the directed graph generation unit 122 performs a process of expressing the connection precedence relationship in which the component is depicted by the node and the connection precedence relationship between the components is depicted by the directed edge based on the detection result of the radial/axial direction component detection unit 121.

The disassembling order proposal generation unit 123 is a functional unit which generates the unit of disassembling and the disassembling order proposal. For example, the disassembling order proposal generation unit 123 performs a process of generating the unit of disassembling and the disassembling order proposal based on the connection precedence relationship of the directed graph generation unit 122.

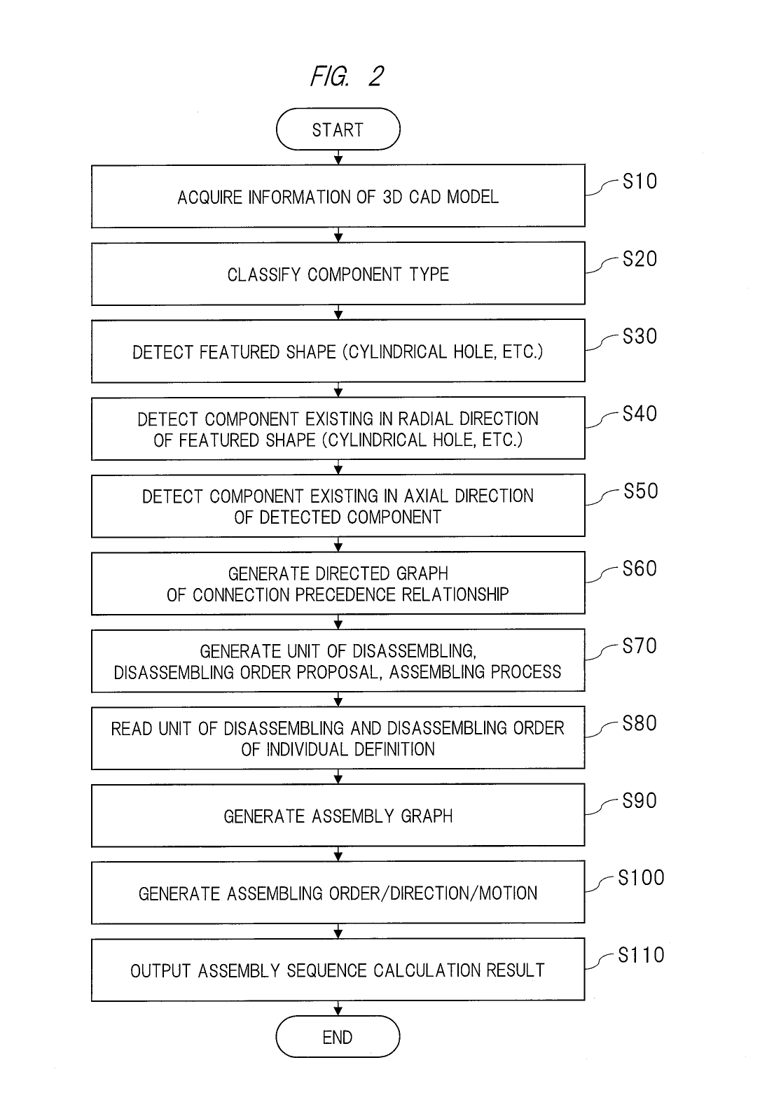

These respective functional units 111 to 115, and 121 to 123 included in the control unit 110 will be described in detail using FIGS. 2, and 5 to 23.

The storage unit 130 of the assembly order generation device 100 includes respective storage regions for 3D CAD model information 131, component type information 132, an analysis calculation program/calculation condition 133, a disassembling order condition/disassembling unit condition 134, a connection precedence relationship directed graph 135, an assembly graph 136, and assembling sequence data 137.

The 3D CAD model information 131 is the 3D CAD data (the evaluation target model: an assembly) acquired by the 3D CAD device 200 and information of the 3D CAD model extracted from the 3D CAD data. The component type information 132 is information to be referred for a process of classifying the component type and detecting the featured shape. The analysis calculation program/calculation condition 133 is a condition of the analysis calculation program of each functional unit and a condition of the analysis calculation. The disassembling order condition/disassembling unit condition 134 is a condition of the disassembling order defined in an arrangement order such as a component type, a size, and a layout position, and a condition of the unit of disassembling besides the connection precedence relationship. The connection precedence relationship directed graph 135 is a graph of the connection precedence relationship analyzed while paying attention to the component type and the featured shape from the 3D CAD model. The assembly graph 136 is a graph of an assembly generated from the adjacency relationship between the components. The assembling sequence data 137 is data of an assembly sequence generated by the assembling order/direction/motion generation unit 115.

### Procedure of Assembly Order Generation Method

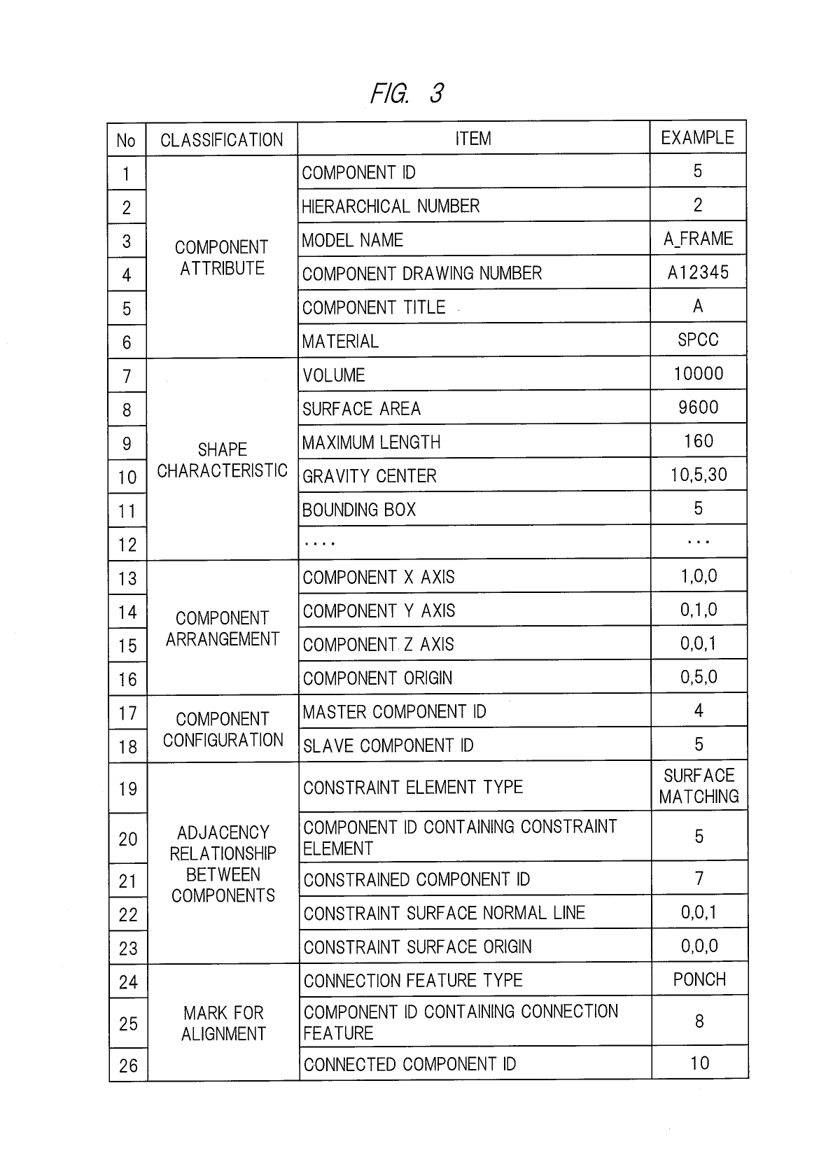

Next, the procedure of the assembly order generation method in the assembly order generation device 100 illustrated in FIG. 1 will be described using FIG. 2 with reference to FIGS. 3 to 23. FIG. 2 is a flowchart for describing an example of a procedure from a process of generating an assembly sequence and an assembling process based on the 3D CAD data to a process of outputting an assembly sequence calculating result in the assembly order generation device 100 according to this embodiment. That is, FIG. 2 illustrates a procedure in which the assembly order generation device 100 generates the directed graph of the connection precedence relationship and the assembly graph based on the 3D CAD data acquired by the 3D CAD device 200, and outputs the assembly sequence calculating result.

### Information Acquisition Process of 3D CAD Model

An information acquisition process of the 3D CAD model of Step S10 of FIG. 2 is performed by the 3D CAD model information acquisition unit 111. The information acquisition process of the 3D CAD model reads the 3D CAD data (the evaluation target model: an assembly) acquired by the 3D CAD device 200, acquires a component configuration of the assembly, the arrangement of the respective components, a model name and a dimension, the component attributes such as a component center position and a component gravity center position, and information of the adjacency relationship between the components, and creates the 3D CAD model information 131 in a format, illustrated in FIG. 3 and stores the 3D CAD model information in the storage unit 130. Here, the evaluation target is an assembly model which is an assembly configured by a plurality of components. Further, the file may be output in the XML format in which the classifications and items are defined as the names of elements and attributes.

FIG. 3 is a diagram illustrating an exemplary table of the 3D CAD model information 131 which is stored in the storage unit 130. The table of the 3D CAD model information 131 includes respective columns of classification, item, and example. The classification includes a component attribute, a shape characteristic, a component arrangement, a component configuration, an adjacency relationship between components, and a mark for alignment, and each classification includes items. Further, some items are omitted from FIG. 3.

As the component attribute and the shape characteristic in the classification column, a component ID, a hierarchical number, a model name, a component drawing number, a component title, a component volume, a surface area, a material, a specific gravity, a weight, a maximum length, a gravity center, a bounding box (coordinates of eight vertexes of a cuboid forming a boundary surrounding the component from the outside) , a principal moment of inertia, and a principal axis of inertia are extracted.

The component arrangement represents a position and a posture of each component on the assembly model arranged in a world coordinate system, and is configured by three axes X, Y, and Z of a part coordinate system and a component origin of each component.

The component configuration is information indicating a master-slave relationship between a sub component and the component of the 3D CAD model, and includes a master component ID, a slave component ID, a flag indicating a sub assembly, and a flag indicating not a target assembly (information not displayed or suppressed on the 3D CAD model) as the data items.

The adjacency relationship between the components is assembly constraint information which is set when the assembly model is subjected to modeling, and is configured by a constraint element type, a component ID containing a constraint element, the component ID which is constrained (a constrained component ID), a constraint surface normal line indicating the constraint surface, and a constraint surface origin. In addition, the assembly constraint information may be acquired not only by information which is set at the time of modeling by a designer, but also by a method using clearance analysis on the components based on the assembly model. Here, as one of the clearance analysis, another model within a clearance distance from each surface of the modeled component is searched based on a predetermined threshold, and information of a position and a posture of the surface (plane, cylindrical surface, conical surface, etc.) of the obtained adjacent component is created from the search result.

Further, constraint surface information obtained by the information on the assembly constraint and the clearance analysis is acquired in the case of the plane by setting a vector facing the outside of the model as a constraint surface normal vector and a point on the surface as the constraint surface origin, and in the case of the cylindrical surface by setting the axial direction of the cylinder as the constraint surface normal vector and a point on the axis as the constraint surface origin.

Furthermore, in the flowchart of FIG. 2, a modeling operation of the 3D CAD model and an operation of designating an analysis target model are omitted.

### Classification Process of Component Type

The classification process of the component type of Step S20 of FIG. 2 is performed by the component type classifying unit 112. In the classification process of the component type, the component type information 132 of the storage unit 130 is read, and the component type of each component stored in the 3D CAD model information 131 acquired in Step S10 is determined based on a condition (for example, a character string of which the head character is designated) of the designated model name or a designated component dimension (for example, whether it is equal to or less than the designated dimension).

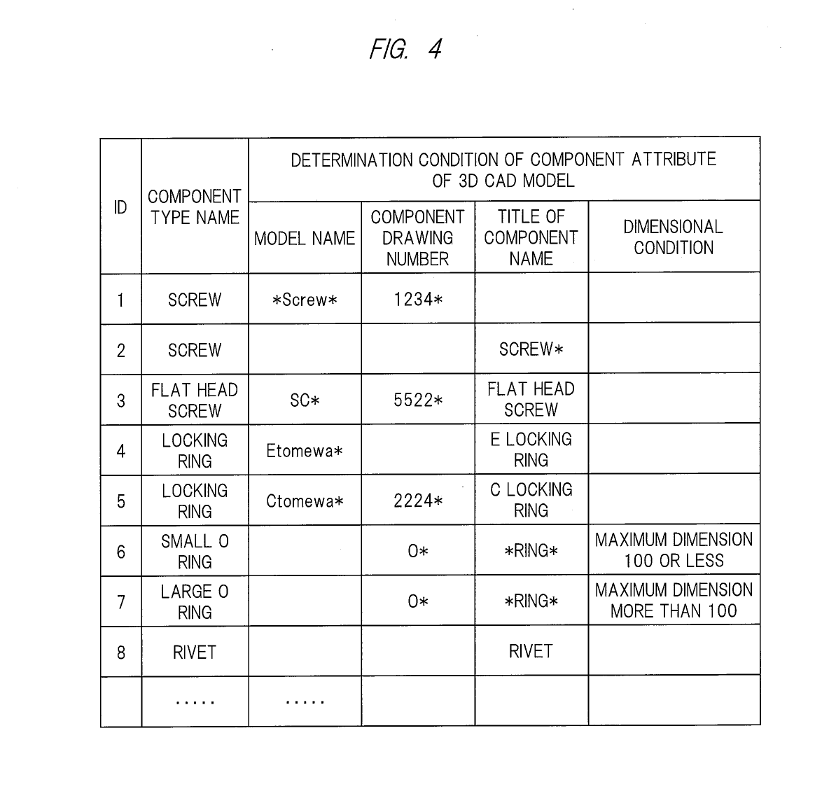

FIG. 4 is a diagram illustrating an exemplary table of the component type information 132 stored in the storage unit 130, which is used in the determination of Step S20. The table of the component type information 132 includes columns of the ID and the name of the component type, and the component attribute of the 3D CAD model.

The component type information 132 includes the component attribute (the model name, the component drawing number, the title of the component name) of the 3D CAD and the determination condition item of the shape characteristic of the 3D CAD as information for selecting the component type, and is configured to identify the component type name and a matching degree under the selection condition of each row using the component type ID. Further, in the example of FIG. 4, the retrieval under the selection condition of each row is performed on the condition of the items except the blank.

Here, the component drawing number and the title of the component name are textual information arbitrarily defined to a part model or an assembly mode of the 3D CAD by the user. In addition, the component attribute of the character string such as the 3D CAD model name and the title of the component name may be selected in a case where the character string is partially matched, not only other than a case where the entire character string is exactly matched. Then, a character string containing a wild card character (* or the like) indicating an arbitrary character is stored.

Further, a character string condition column may be added to define a condition such as exact matching, front part matching, rear part matching, and the like. In addition, besides the example of a dimensional condition, a weight characteristic obtainable by calculating the 3D CAD model such as a vertex of the bounding box in the part model, a gravity center, a principal moment of inertia, and the like may be stored as the shape characteristic . In addition, the numerical values are determined under conditions indicating ranges such as same, equal to or less, larger, and the like, and these conditions may be subjected to logical AND/OR.

### Detection Process of Featured Shape (Cylindrical Hole, Etc.)

A detection process of the featured shape (the cylindrical hole, etc.) of Step S30 of FIG. 2 is performed by the featured shape detection unit 113. In the detection process of the featured shape (the cylindrical hole, etc.), the designated featured shapes (the cylindrical hole, etc.) of all the components of an assembly model are detected. Here, the featured shape is a designated shape in a fitting relationship between the components such as the cylindrical hole, a partial cylinder (an unclosed cylinder) having an angle R and a long arc, and a circular ring.

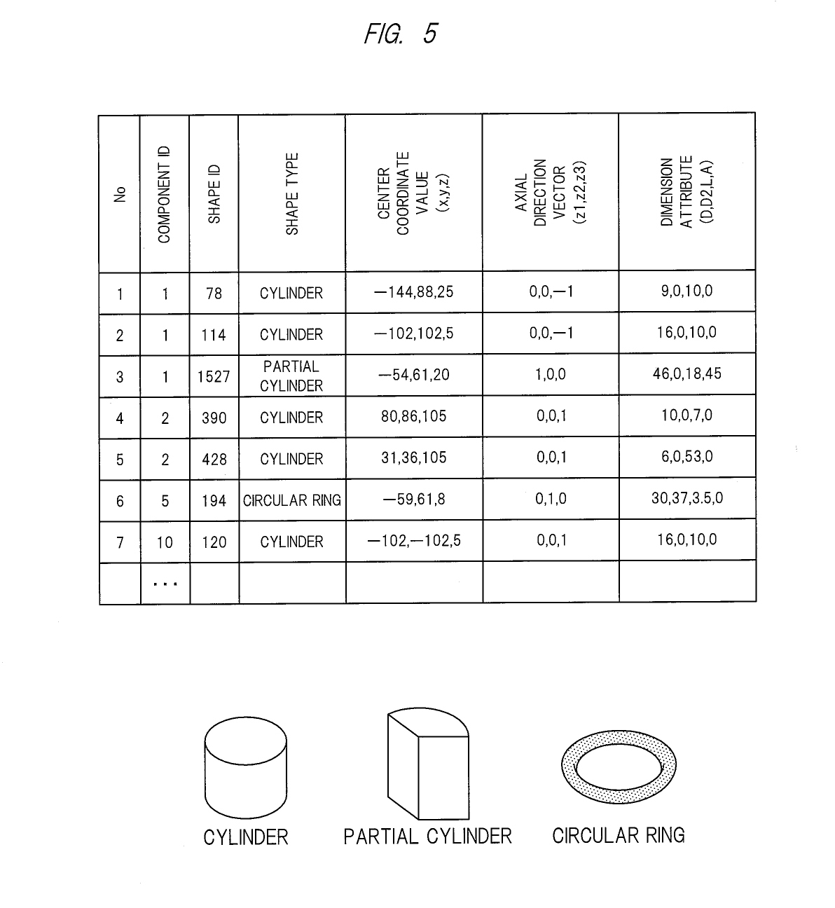

FIG. 5 is a diagram illustrating an exemplary result obtained when the cylindrical hole, the partial cylinder, and the circular ring are detected from the assembly model. The detection result includes columns of a component ID, a shape ID, a shape type, a center coordinate value, an axial direction vector, and a dimension attribute.

In the detection result, the shape ID is included in each component ID, and is output as unique information by a combination identification key of two types of IDs. In the shape type, the types of the cylinder, the partial cylinder, and the circular ring are output. In addition, the center coordinate value indicating a position of the shape, the axial direction vector indicating a posture of the shape, and the dimension attribute indicating a size of the shape are output. Here, the center coordinate value is a coordinate value (x, y, z) in the world coordinate system of the assembly model, the axial direction vector is a unit vector (z1, z2, z3) in the world coordinate system, the dimension attribute includes values of D, D2, L, and A, D is an inner diameter, D2 is an outer diameter in the case of the circular ring, L is a length, and A is an open angle in the case of the partial cylinder.

### Detection Process of Component Existing in Radial Direction of Featured Shape (Cylindrical Hole, Etc.)

The detection process of the component existing in the radial direction of the featured shape (the cylindrical hole, etc.) of Step S40 of FIG. 2 is performed by the radial/axial direction component detection unit 121. In the detection process of the component existing in the radial direction of the featured shape (the cylindrical hole, etc.), a light beam is emitted and scanned from the center of the featured shape detected in Step S30 (for example, the cylindrical, the partial cylinder, the circular ring of the exemplary outputs illustrated in FIG. 5) onto the 3D model in the outward radial direction, and a surface firstly crossing with the light beam is detected. As the surface information, a component ID, a surface ID, and a distance up to the surface are acquired. This process may be performed using a command such as a light beam trace or a ray tracing of an API (Application Programming Interface) of the 3D CAD. The surface information and the distance up to the crossing surface can be acquired by designating a light beam start point and a direction of the light beam.

Further, since two half cylinders are generally combined to form one cylinder in the case of the cylindrical shape, the radial direction is set to a direction toward a position at which the arc of the half cylinder is equally divided into two parts. In addition, the radial direction is set to a direction toward a position at which the arc is equally divided into two parts in the case of the partial cylinder. In the case of the circular ring, the radial direction is set to an arbitrary direction. Further, while not described in the case of the circular ring, there may be a case where the circular ring is an unclosed ring. In this case, similarly to the partial cylinder, the radial direction is set to a direction toward a position at which the arc is equally divided into two parts.

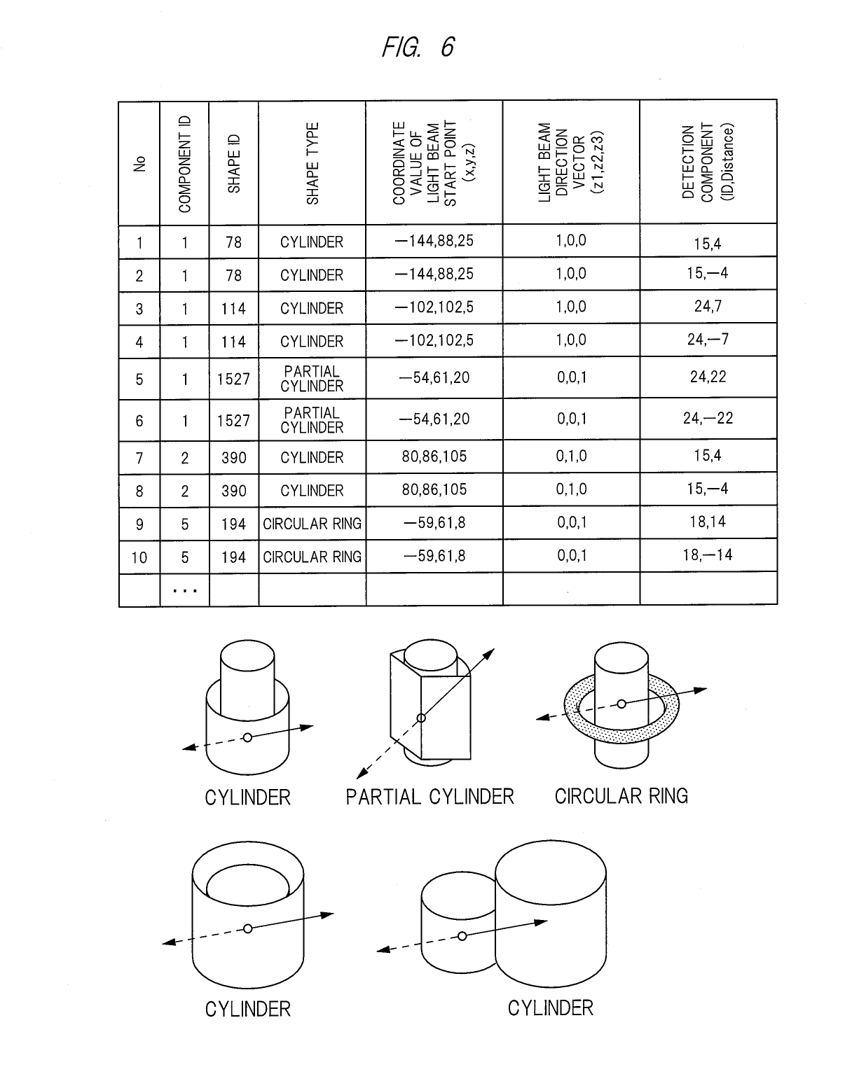

FIG. 6 is a diagram illustrating an example of a component and an output distance of the component detected by emitting the light beam in the radial direction of the cylindrical hole. The detection result includes respective columns of a component ID, a shape ID, a shape type, a coordinate value of the light beam start point, a light beam direction vector, and a detection component.

In the detection result, the detected component ID and the distance (Distance) are attached by a positive or negative sign according to a result obtained by emitting and scanning the light beam from the coordinates (x, y, z) of a light beam start point along a light beam direction vector (z1, z2, z3) with respect to each shape such as the cylinder uniquely determined by the combination identification key of the component ID and the shape ID. Further, the positive (+) sign is omitted in FIG. 6. For example, in the examples of No. 1 and 2, the component of the component ID “15” is detected at distances +4 mm and −4 mm from the light beam start point as a result of the light beam scan in the radial direction of the cylindrical hole of the inner diameter “9” illustrated in FIG. 5. In the examples of No. 9 and 10, the component of the component ID “18” is detected at distances +14 mm and −14 mm from the light beam start point as a result of the light beam scan of the circular ring of the inner diameter “30” illustrated in FIG. 5.

Further, a component to be inserted into a hole is modeled on the 3D CAD model using an axis larger than the hole shape, and the hole and the axis may be interfered to each other. For example, in the case of a female screw and a male screw, the female screw is modeled using a female screw inner diameter or a lower hole diameter, and the male screw is modeled using a screw external form in many cases. In this case, in the light beam scan of the radial direction of the cylindrical hole, it is not possible to detect a surface of the male screw portion in a process within a range up to the female screw inner diameter. On the other hand, all the results within a range of an external enveloping cuboid covering the entire assembly in the light beam scan can be output, but a process of narrowing and reading from the results is redundant. Therefore, at the time of the light beam scan in the radial direction, the light beam is emitted from the center of the hole in the radial direction, and the information obtained by emitting the light beam to its own outside surface is output instead of emitting the light beam to its own inside surface. At this time, in a case where only one side in the positive direction of the light beam is detected, it is determined that the detected component is unrelated to the hole. In a case where both sides in the positive direction are detected, it is determined that the detected component is related to the hole.

In addition, in FIG. 6, the description has been made about an example in which the center of the cylindrical hole is the light beam start point, but the light beam start point maybe shifted on both sides in the axial direction of the cylindrical hole and emit the light beam from the center of the end portion to detect the related component. However, when the number of light beams for the scanning and the number of components of the assembly are increased, it takes a time for a calculation process. Therefore, it is desirable that the number of light beams for the scanning be decreased as small as possible. Then, the length in the axial direction is ascertained by a length L of the dimension attribute value of the detected shape illustrated in FIG. 5, and is compared with a predetermined threshold. Ina case where the length is equal to or more than the threshold, a process of adding the light beam scan on both end surfaces is added.

### Detection Process of Component Existing in Axial Direction of Detected Component

The detection process of the component existing in the axial direction of the component detected in Step S50 of FIG. 2 is performed by the radial/axial direction component detection unit 121. In the detection process of the component existing in the axial direction of the detected component, a component existing in the axial direction of a related component (hereinafter, referred to as a fastening component) of the hole obtained by the detection process of the component existing in the radial direction of the featured shape (the cylindrical hole, etc.) of Step S40 is detected. Herein, the assembling directions of a bolt and a locking screw of a standard fastening component, an E ring, and a C ring can be defined according to their own shapes. For example, a direction from the screw head toward the screw end is the assembling direction of the screw component. Therefore, the assembling direction defined for each component shape can be recognized by the classification process of the component type of Step S20 of FIG. 2.

In addition, even in a case where the assembling direction is defined for each component type in advance, the assembling direction of the standard fastening component can be derived from its shape. Since the assembling direction of the screw component is a direction from the screw head to the screw end and the assembling direction of the E ring or the C ring is a direction from a closed side to an opened side, a direction from the center to the gravity center of the component can be derived as the disassembling direction of the subject component based on the component shape of the 3D CAD. In general, the component related to the hole detected in Step S40 is the screw component in many cases, and the disassembling direction thereof is derived by the above method.

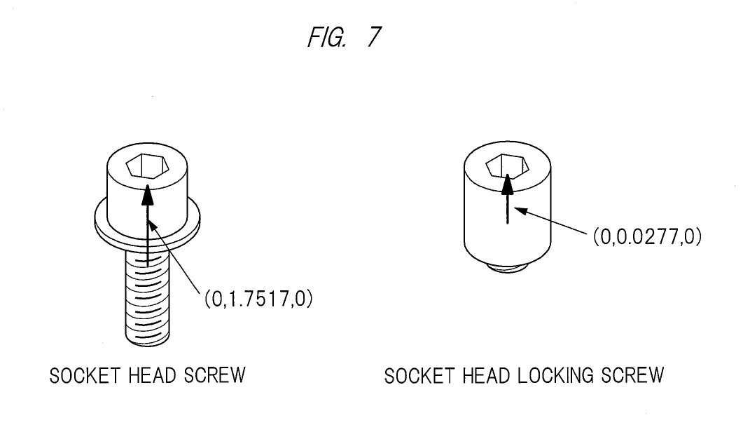

FIG. 7 is a diagram illustrating an exemplary calculation result of a vector from the center to the gravity center of the fastening component. Specifically, the calculation results from the centers to the gravity centers of a socket head screw and a socket head locking screw are illustrated. In a standard screw component, the disassembling direction can be correctly derived from the shape of the 3D CAD.

In the derived disassembling direction (the axial direction) of the fastening component, the light beam is emitted and scanned to the surface in order to detect an obstacle component similarly to the component detection process in the radial direction. At this time, the component is irradiated and scanned with the light beam on the center axis. Further, the light beam is also emitted and scanned in a direction shifted to the outer end in parallel to the center of the component. For example, in the case of the socket head screw illustrated in FIG. 7, the component may be detected to be an obstacle in the screw head even though the obstacle component is not found out in the light beam scan only on the center axis.

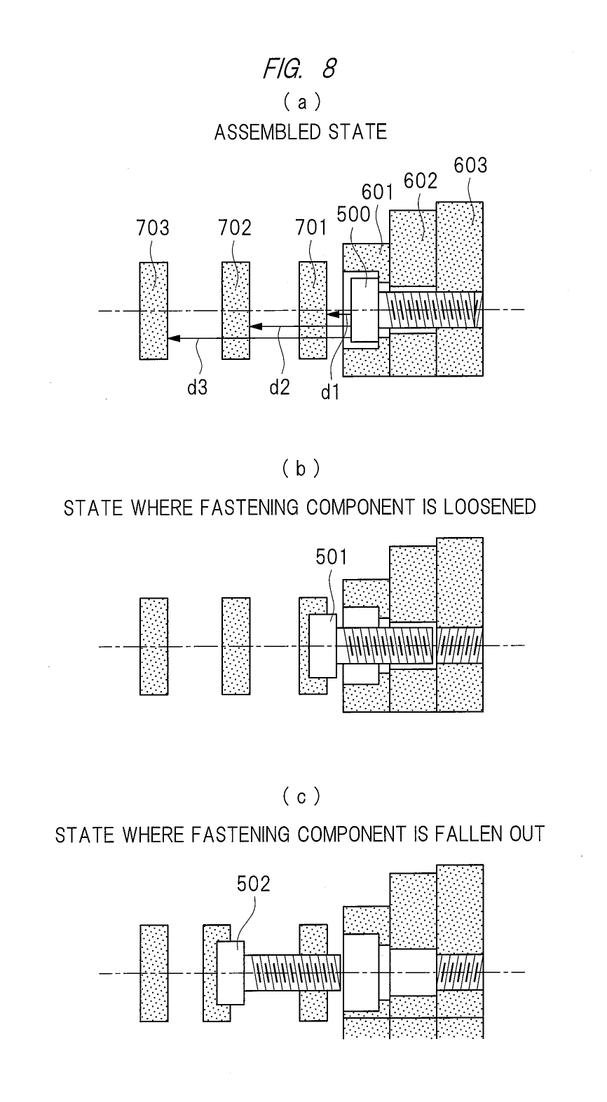

FIG. 8 is a diagram for describing a method of detecting an obstacle component in a light beam scan of an axial direction of a disassembling direction of the fastening component, in which (a) illustrates an assembled state, (b) illustrates a state where a fastening portion is loosened, and (c) illustrates a state where the fastening component is fallen out.

Since the light beam scan is performed in the assembly model of the 3D CAD, it becomes a process in the assembled state of FIG. 8(a). As a result, the cylindrical hole is detected in Step S30 of FIG. 2, the light beam scan is performed in the radial direction of the cylindrical hole of a component 601, the cylindrical hole of a component 602, and the cylindrical hole of a component 603 in Step S40 to detect a fastening component 500. Then, the light beam is emitted in the disassembling direction (the axial direction) of the fastening component 500 in Step S50, distances to the surfaces of components 701, 702, and 703 of FIG. 8 near the light beam start point are output. These distances are set as d1, d2, and d3. Further, the arrows extending from the fastening component 500 of FIG. 8 are illustrated to face different positions for the sake of explanation, but a point on the center axis of the fastening component or on the outside of the component is set as the light beam start point.

Here, the distances obtained by the light beam scan are output as values having the same sign as that of the radial direction, and the disassembling direction is set as a positive direction. In addition, at this time, a maximum end point on the optical axis of the fastening component is set in the calculation of the distance as illustrated by the arrows of FIG. 8, and a distance up to the surface near the component hindering the disassembling is output. Further, as illustrated in FIG. 3, the center of the component, the gravity center of the component, and coordinates of the vertexes of the external enveloping cuboid (the bounding box) are acquired in the process of Step S10 of FIG. 2, and the light beam start point is set as the center of the component to derive the distance. Then, the distance up to the component which is an obstacle in the disassembling direction may be calculated.

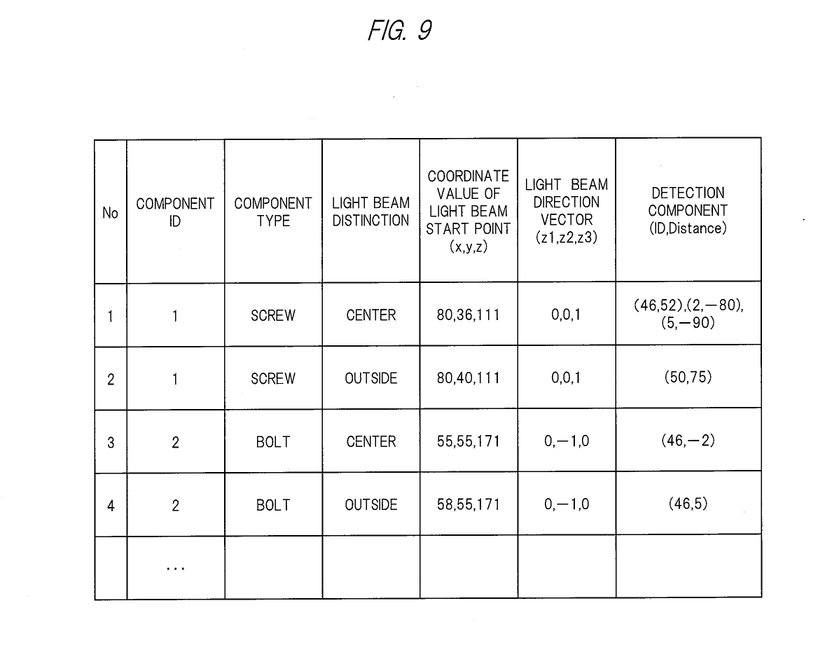

FIG. 9 is a diagram illustrating an exemplary output obtained as a result of the light beam scan in the disassembling direction (the axial direction) of the fastening component. The result of the light beam scan in the axial direction of the disassembling direction of the fastening component includes respective columns of a component ID, a component type, a light beam distinction, a coordinate value of the light beam start point, a light beam direction vector, and a detection component. In the result of the light beam scan, the component ID of the fastening component subjected to the light beam scan, the component type, the distinction of the center or the outside of the fastening component as the light beam distinction, the coordinate value of the light beam start point, the unit vector indicating a light beam direction, the component ID of the component detected in the light beam scan, and the (signed) distance are output.

FIG. 8(b) is a diagram illustrating a state where the fastening component is loosened by the female screw length of the fastening portion, and FIG. 8(c) is a diagram illustrating a state where the fastening component is fallen out. In this way, a disassembling distance until being fallen out of each cylindrical hole can be ascertained from the coordinates of the light beam start point and the component ID in the light beam scan of the radial direction. In the state where the fastening portion is loosened in FIG. 8(b) (a fastening component 501) and the state where a fastening component 502 is fallen out in FIG. 8(c), the component ID and the distances causing an obstacle are derived by the light beam scan of the assembled state of FIG. 8(a).

In addition, while not illustrated in FIG. 8, a component causing an obstacle in a state where a tool for assembling the fastening component and a work area of a hand are taken into consideration is detected in the same way.

Further, the above description has been made about that the detection is performed in the respective states, and as a process, a distance from the light beam start point to the detected surface is output, and the respective states are distinguished based on the distance and the coordinate values of the cylindrical holes and the ends of the fastening component.

### Generating Process of Directed Graph of Connection Precedence Relationship

The generating process of the directed graph of the connection precedence relationship of Step S60 of FIG. 2 is performed by the directed graph generation unit 122. In the generating process of the directed graph of the connection precedence relationship, the relationship is expressed in a graph based on the results of the light beam scan obtained in Steps S40 and S50. In the graph herein, the component ID is expressed as a node (circle), and the connection precedence relationship between the components is expressed as a directed edge (an edge or side having a direction).

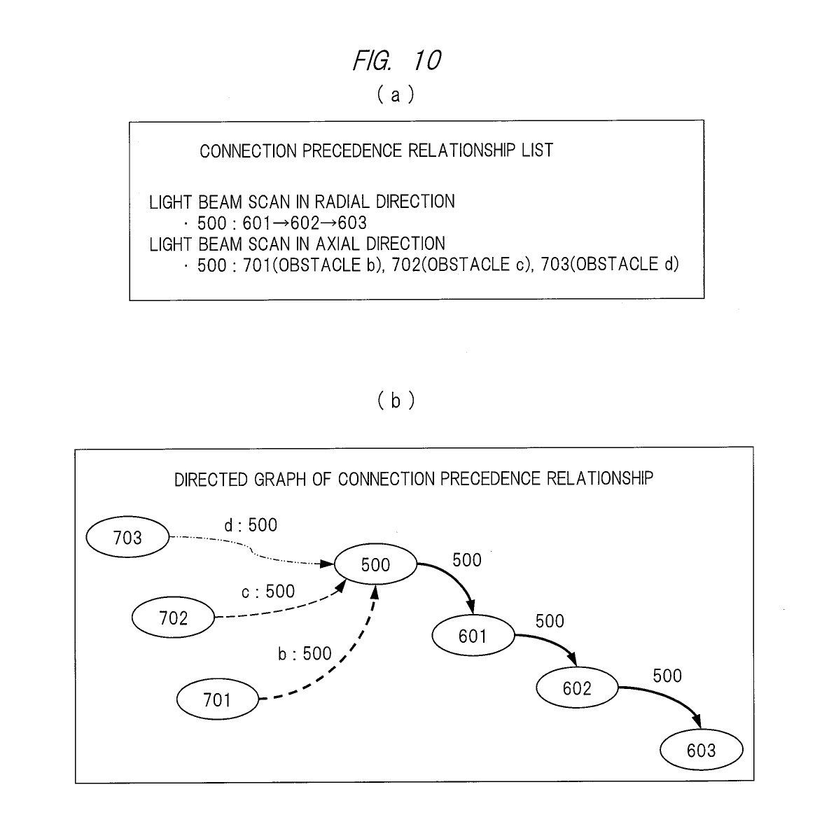

FIG. 10 is a diagram for describing an example of a connection precedence relationship list (a) and a directed graph of a connection precedence relationship (b) obtained as a result of the light beam scan. In FIG. 10, the graph is expressed and drawn based on the connection precedence relationship obtained from the result of the light beam scan of the assembled state of FIG. 8(a). Here, the symbols described in FIG. 8 are set as the component IDs.

As illustrated in FIG. 10, the connection precedence relationship is expressed by the directed graph (b) based on the connection precedence relationship list (a) of the results of the light beam scan in the radial direction and the axial direction. Specifically, as illustrated in FIG. 8(a), the fastening component of the component ID 500 is detected from the results of the light beam scans in the redial directions of the respective cylindrical holes of the component IDs 601, 602, and 603, the light beam start points of the respective cylindrical holes are ascertained, and the respective coordinate values are projected onto the axis in the disassembling direction of the fastening component, so that the arrangement order of the cylindrical holes with respect to the fastening component can be derived. As a result, it can be known that the components in the fitting relationship are in an arrangement order of 601→602→603 of the component ID with respect to the fastening component 500. In addition, the component ID and the distance causing an obstacle in the respective states as illustrated in FIG. 8 can be ascertained from the result of the light beam scan of the disassembling direction of the fastening component. For example, in a case where the components are distinguished as b, c, and d in an order near the fastening component, it can be ascertained that the components of the component IDs 701 (obstacle b), 702 (obstacle c), and 703 (obstacle d) are obstacles when the fastening component 500 is disassembled from a result of the light beam scan in the axial direction.

FIG. 10(b) illustrates an example of a graph drawn based on the connection precedence relationship list of FIG. 10(a). The component ID is expressed as a node, and the connection precedence relationship between the components is expressed as a directed edge. In FIG. 10(b), the result of the light beam scan in the radial direction is depicted by a solid line, and the result of the light beam scan in the axial direction is depicted by a broken line, a dotted line, or a dashed line. Therefore, it can be ascertained that the components 601, 602, and 603 are disassembled by disassembling the fastening component 500, and the components 701, 702, and 703 become obstacles against the disassembling of the fastening component 500.

### Generating Process (1) of Unit of Disassembling, Disassembling Order Proposal, and Assembling Process

The generating process of the unit of disassembling and the disassembling order proposal of Step S70 of FIG. 2 is performed by the disassembling order proposal generation unit 123. In the generation process of the unit of disassembling and the disassembling order proposal, the unit of disassembling and the disassembling order proposal are derived based on the connection precedence relationship.

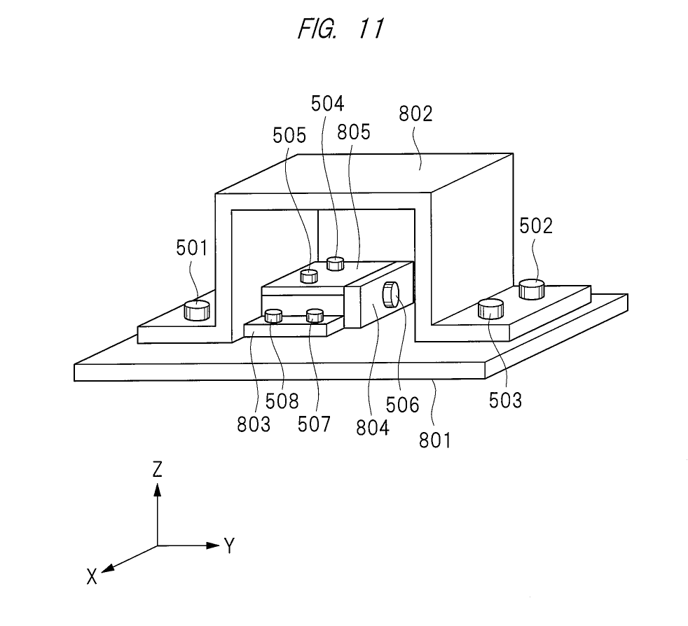

The description will be made using the example of the 3D CAD assembly model illustrated in FIG. 11. FIG. 11 is a diagram for describing an example of the 3D CAD assembly model. Here, the symbols denoted in FIG. 11 will be described as the component IDs. In the assembly model of FIG. 11, a component 803 comes in contact with a component 801, and is fastened by screws 507 and 508 in a −Z axial direction. In addition, the component 803 comes in contact with a component 805 in the upper surface and with a component 804 in the side surface, and is respectively fastened thereto by screws 504 and 505 in the −Z axial direction and by a screw 506 in a −Y axial direction. In addition, a component 802 comes in contact with the component 801, and is fastened by a screw 501 in one side surface and by screws 502 and 503 in the other surface in the −Z axial direction.

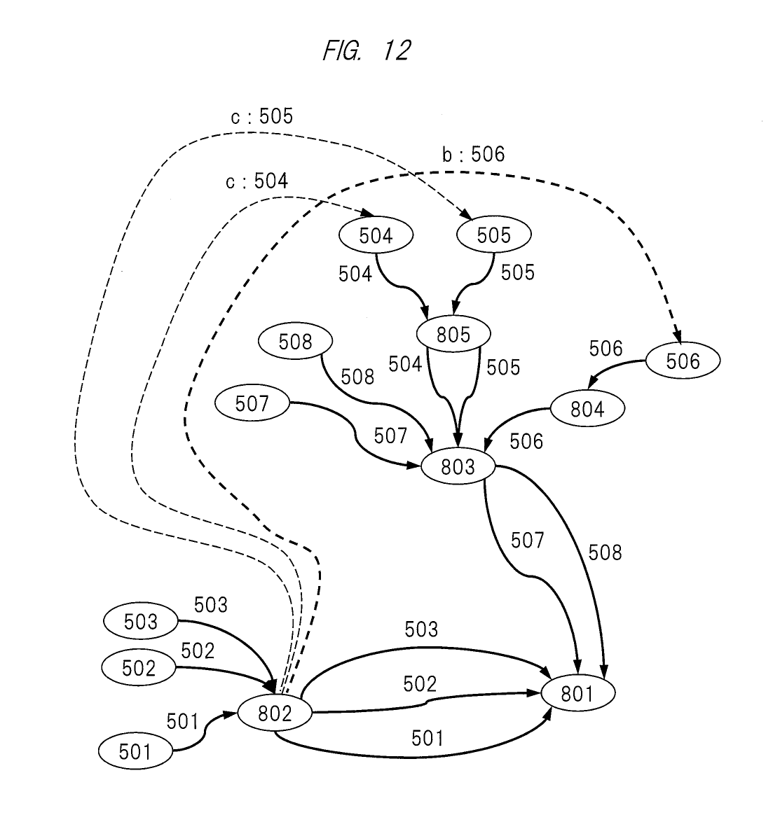

The connection precedence relationship directed graph obtained from an analysis result of the assembly model of FIG. 11 in Step S60 is illustrated FIG. 12 similarly to the result drawn in FIG. 10. FIG. 12 is a diagram for describing an example of the connection precedence relationship directed graph of the assembly model of FIG. 11. In FIG. 12, the fastening component 501 is in the connection relationship of the components 802→801, the fastening components 502 and 503 are in the connection relationship of the components 802→801, the fastening components 504 and 505 are in the connection relationship of the components 805→803, the fastening component 506 is in the connection relationship of the components 804→803, and the fastening components 507 and 508 are in the connection relationship of the components 803→801. In addition, in FIG. 12, the fastening component 506 is hindered by the component 802 at a distance of an obstacle section b, and the fastening components 504 and 505 are hindered by the component 802 at a distance of an obstacle section c.

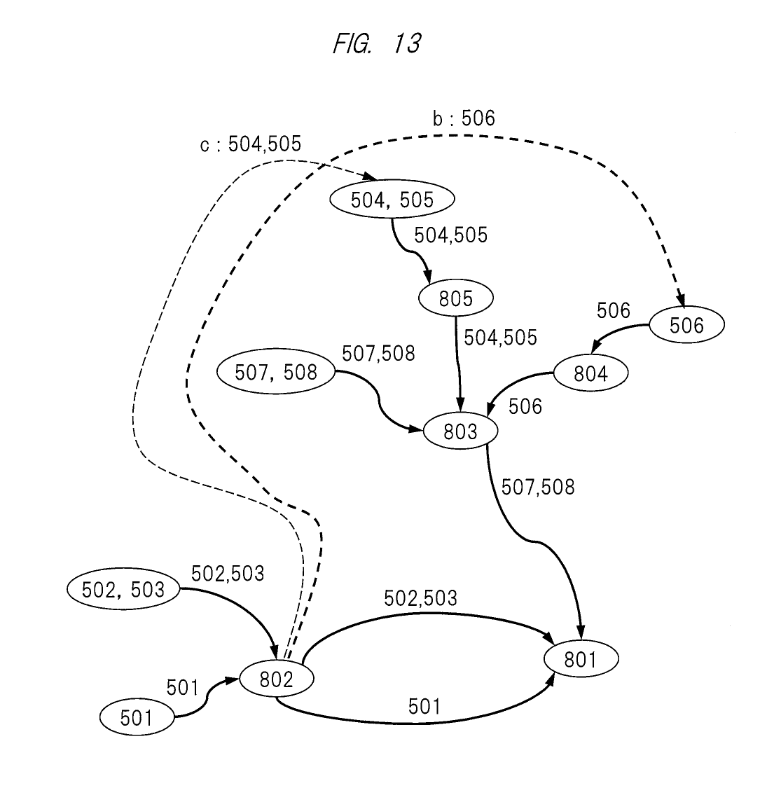

Here, the components of the same name as the model name on the same 3D CAD model, the components to be assembled in the same direction with respect to the same surface, and the components of the same combination with respect to an assembled component are condensed to reduce the number of nodes in the graph. The resultant graph is illustrated in FIG. 13. At this time, the same obstacle sections are also condensed. FIG. 13 is a diagram for describing an example of the connection precedence relationship directed graph in which the components having the same name and the same assembling direction in FIG. 12 are condensed. In FIG. 13 of the condensed result, the nodes and the edges are reduced compared to the graph of FIG. 12 and the calculation process is easily performed. The disassembling order is derived from FIG. 13. Basically, the disassembling order is set to be disassembled from a component having no inner arrow. The arrow is a directed edge connected between the component nodes, in which the arrow having an inner arrow with respect to the node is described as an inner edge, and the arrow going out is described as an outer edge. In the example of FIG. 13, the fastening components 501, (502, 503), and (507, 508) correspond to the node having no inner edge.

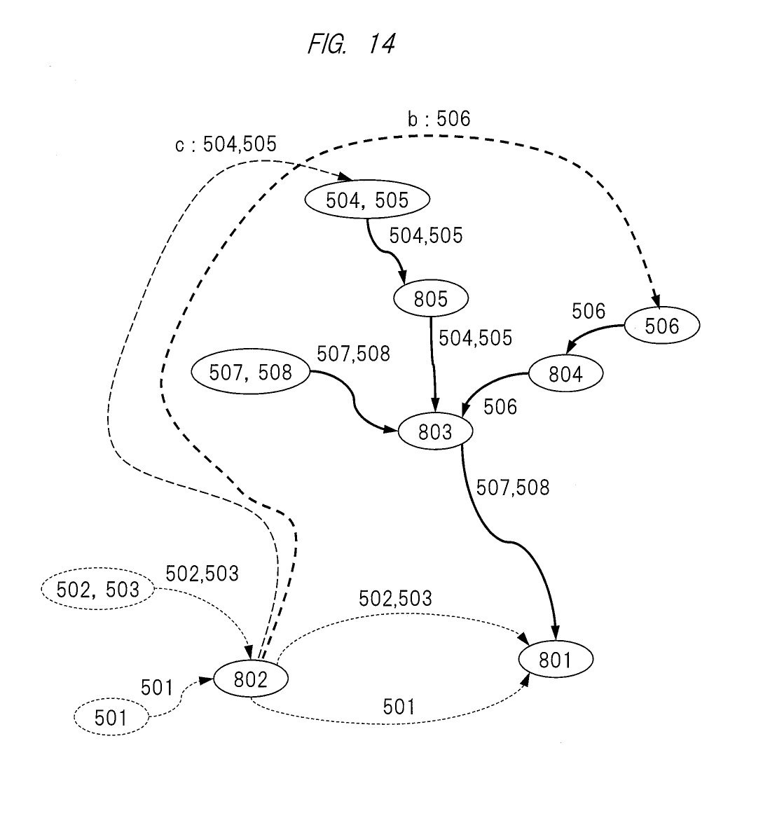

At this time, a disassembling start condition is set by a condition rule for determining the disassembling order (for example, “the component arranged in the upward direction is first disassembled”, “the disassembling operation of the upward direction is first performed”) defined in advance in a disassembling order condition of the disassembling order condition/disassembling unit condition 134 of FIG. 1. In a case where the determination is not made only by the connection precedence relationship, the order is determined based on the disassembling order condition. For example, in a case where 501 and (502, 503) are disassembled earlier, the connection relationship is released and comes to be the state of FIG. 14. FIG. 14 is a diagram illustrating an exemplary state in which the fastening components 501 to 503 in FIG. 13 are disassembled. In FIG. 14, the disassembled component node and the edge thereof are depicted by a thin dotted line. Next, it is determined whether the disassembling can be made in an order of the components 802 and 801 which are in the connection relationship with the disassembled fastening component. Further, the disassembling direction of the fastening component is already derived when the analysis process of the light beam, and the direction is set as the disassembling direction. At this time, the component having the inner edge indicates that there is a component to be disassembled first. It can be determined that the component 802 having no inner edge can be disassembled, and the component 801 having the inner edge cannot be disassembled.

Next, as a result of disassembling the component 802, the fastening component 506 and the fastening components (504, 505) ascertained as the obstacle sections b and c are enabled to be disassembled. Similarly to the above description, an order of components among a plurality of disassembling candidates having no inner edge is determined based on the disassembling order condition of the disassembling order condition/disassembling unit condition 134 of FIG. 1. Next, the fastening components (504, 505) are disassembled based on this condition. As a result, since the connection relationship of the components 805 and 803 is released, similarly the next disassembling order is determined and the disassembling order proposal is determined.

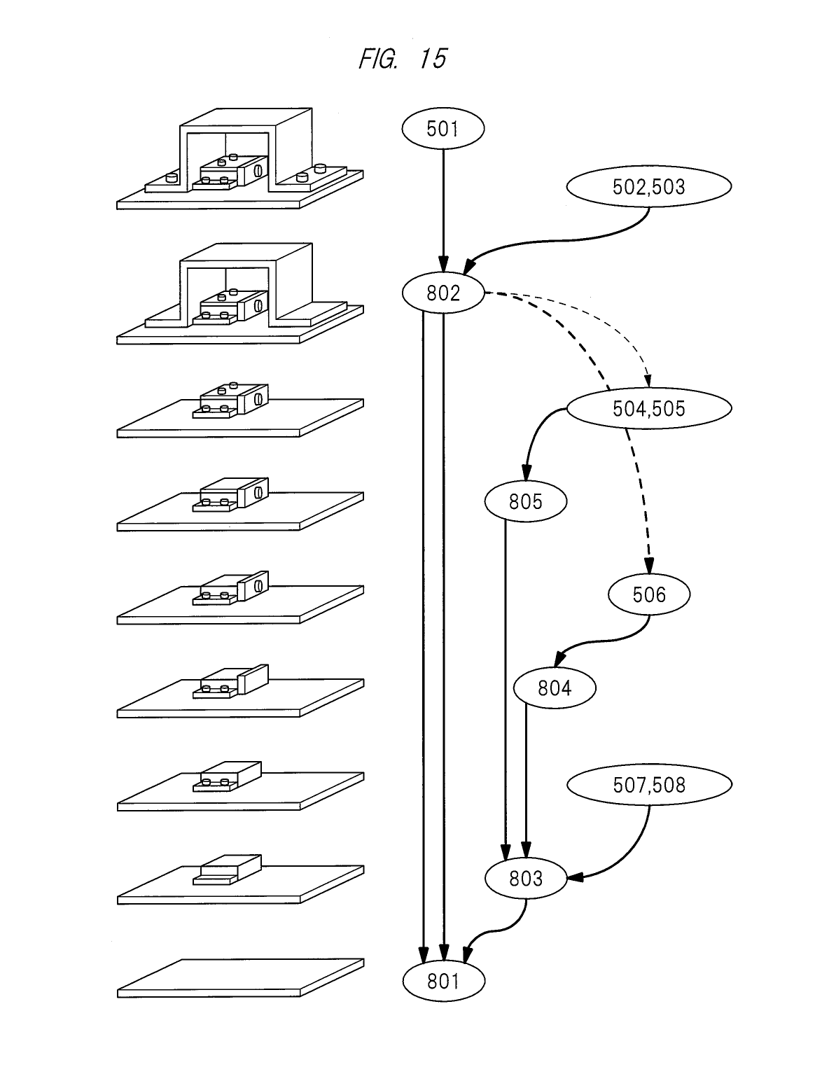

FIG. 15 is a diagram illustrating an exemplary assembling process which is generated from the connection precedence relationship directed graph of FIG. 13. FIG. 15 is a diagram illustrating a result of sorting the connection precedence relationship directed graph along the derived disassembling order proposal based on the connection precedence relationship generated by the above method, and disassembling images for each disassembling order of the assembly mode along the graph. It can be seen from FIG. 15 that the disassembling order can be correctly calculated by deriving the disassembling order based on the connection precedence relationship.

### Generating Process (2) of Unit of Disassembling, Disassembling Order Proposal, and Assembling Process

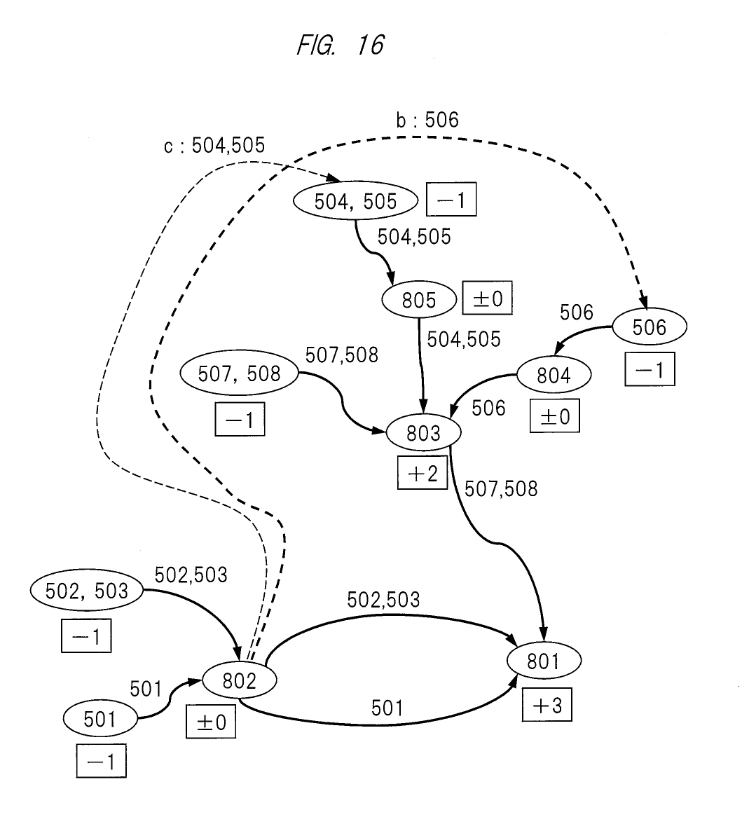

In the above, the description has been made about a basic method (first example) of deriving the disassembling order in an order of selecting the component node having no inner edge based on the connection precedence relationship of FIG. 12. Then, in a case where there are a large number of components, it is necessary to separate a plurality of work processes by stages. A method of deriving the assembling process according to a second example will be described using FIGS. 16 to 18.

FIG. 16 is a diagram illustrating an exemplary calculation of the number of inward/outward arrows generated in the assembling process with respect to FIG. 13. In FIG. 16, the number of inward/outward arrows at each component node (that is, a difference between the inner edge and the outer edge) is calculated with respect to the condensed result of FIG. 13, and the result is denoted at the node by the numerical value in a rectangular frame. Further, in FIG. 16, only the connection relationship in the radial direction is used to calculate the number of inward/outward arrows. The component node of which the number of inward/outward arrows is a negative value can be determined as a component to be disassembled first, and the component node having a positive value can be determined as a component which includes a lot of components to be fastened and as a component serving as a base component. The component nodes may be sorted based on the result and the determination of whether there is an inner edge, or the same disassembling order as that of FIG. 15 may be derived.

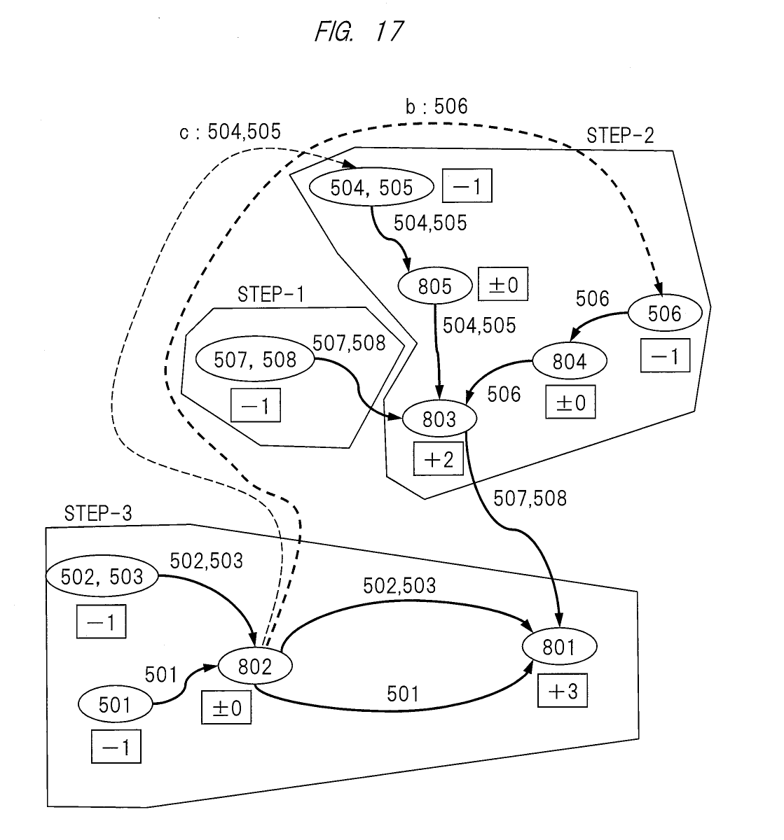

In addition, a subassembly proposal (that is, a method of deriving the assembling process) will be described while paying attention to the positive component node based on the number of inward/outward arrows illustrated in FIG. 16. In FIG. 16, the components 803 and 801 having the positive value are components to which a plurality of components are connected by arrows, so that it can be determined as the base component. Therefore, directed edges (507, 508) connecting a subassembly having the component 803 as a base and a subassembly having the component 801 as a base are considered as a total assembly operation, and thus the process is separated based on the relationship of the components connected at the edges all the way to the base component. The result is illustrated by rectangles of FIG. 17.

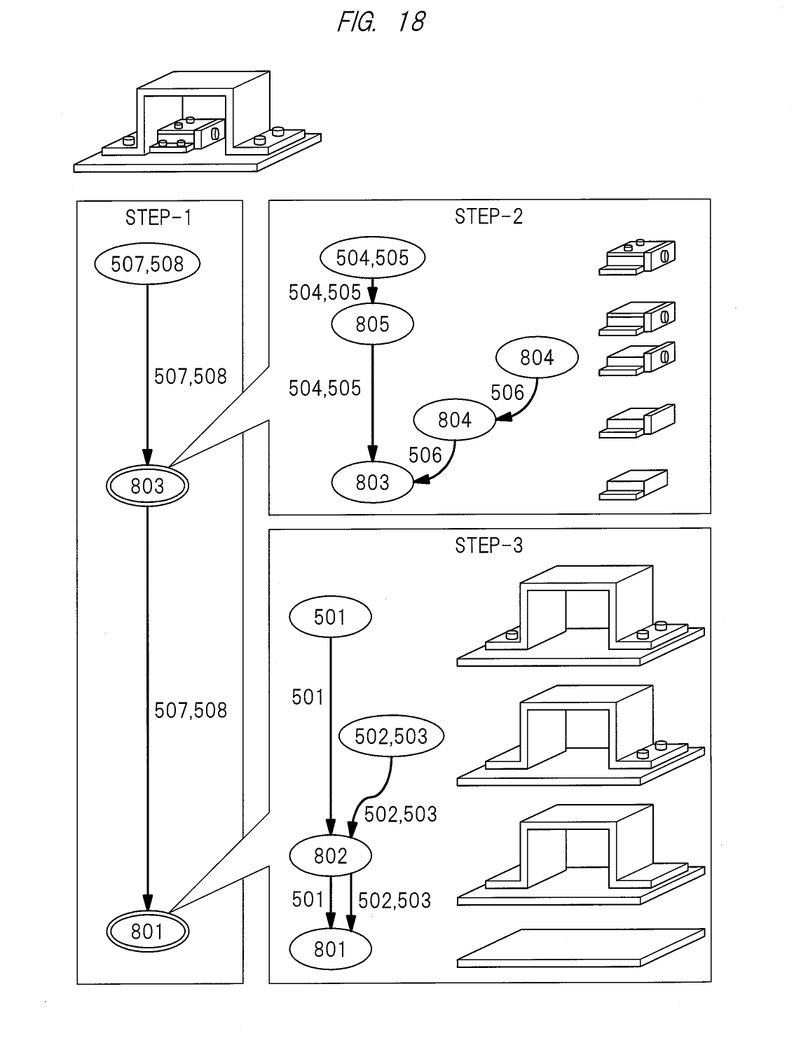

FIG. 17 is a diagram illustrating an example of deriving the assembling process based on the number of inward/outward arrows of FIG. 16. As illustrated in FIG. 17, the assembly components are roughly divided into three rectangles depicted by the assembling process (STEP), and the respective divided groups depicted by the rectangles are attached by numbers sorted in the disassembling order based on the connection precedence relationship (the direction of arrow) as an order of STEP-1, STEP-2, and STEP-3 illustrated in FIG. 17. A flow of the resultant disassembling order is illustrated in FIG. 18.

FIG. 18 is a diagram for describing an example of the derived exemplary assembling process of FIG. 17. As illustrated in FIG. 18, the total assembling order of “a subassembly having the component 801 as a base and a subassembly having the component 803 as a base are assembled by the fastening components 507 and 508”, and the connection relationship of a subassembly up to the base component 803 and a subassembly up to the base component 801 are expressed by the connection precedence relationship in tooltips, and the assembling process including the subassembly work can be derived.

### Generating Process (3) of Unit of Disassembling, Disassembling Order Proposal, and Assembling Process

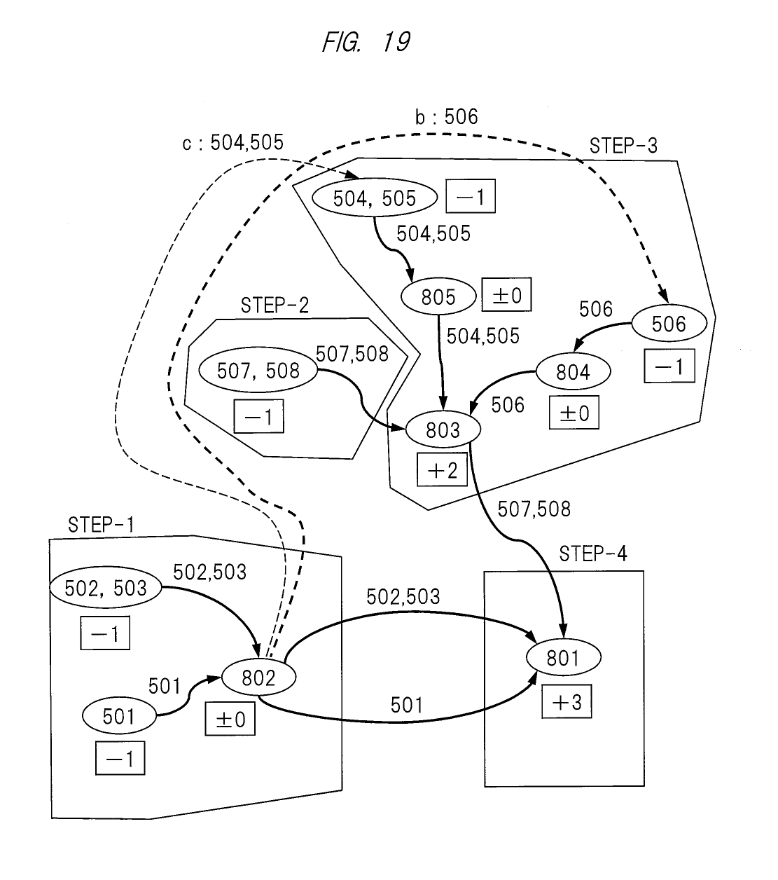

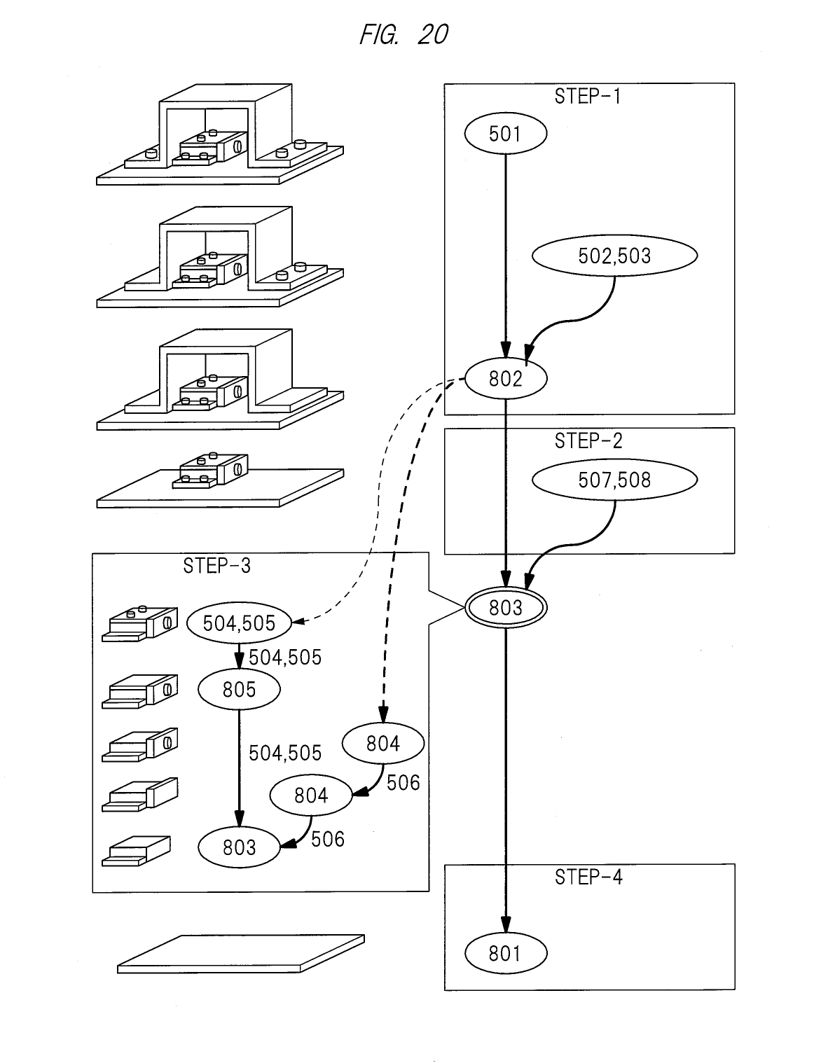

In the method described in FIGS. 16 to 18, the connection relationship obtained from the light beam scan in the axial direction illustrated in FIG. 16 is not considered. Next, as a third example, the generation of the assembling process where an order of obstacle components in the disassembling direction is taken into consideration will be described using FIGS. 19 and 20.

In FIG. 17, the component 802 in STEP-3 becomes an obstacle in the section b when the fastening component 506 is disassembled, and becomes an obstacle in the section c when the fastening components 504 and 505 are disassembled. Therefore, it is not possible that an obstacle component to disassembling other components is contained in the subassembly having the subassembly 801 as a base. Therefore, the process of the component node detected as an obstacle component (that is, the component having the outer edge depicted by the broken line) is separated on the outer edge and added in the assembling process proposal of FIG. 17. The result is illustrated in FIG. 19.

FIG. 19 is a diagram illustrating an example in which the assembling process is derived in consideration of an order of obstacle components detected at the time of disassembling in FIG. 17. In FIG. 19, the process is separated on the outer edge depicted by the broken line of the component 802 detected as the obstacle component in STEP-3 of FIG. 17, and as a result a separated process of the component 801 (STEP-4) is added. The order of processes is rearranged based on the connection precedence relationship between the separated processes. The assembling process generated based on the result is illustrated in FIG. 20.

FIG. 20 is a diagram for describing an example of the derived assembling process of FIG. 19. As illustrated in FIG. 20, it is possible to derive the assembling process based on the order “the component 802 is an obstacle in the disassembling directions of the fastening components 504, 505, and 506, and thus disassembled first”.

### Reading Process of Unit of Disassembling, and Disassembling Order of Individual Definition

The reading process of the unit of disassembling and the disassembling order of the individual definition of Step S80 of FIG. 2 is performed by the disassembling order proposal generation unit 123. In the reading process of the unit of disassembling and the disassembling order of the individual definition, a case where the determination is not possible in the connection precedence relationship obtained by the light beam scan is defined in advance, and the unit of disassembling and the disassembling order are derived according to this rule. For example, a relationship with the component having a groove shape which abuts on or interfered with the shape of an O ring is acquired by the light beam scan, but the O ring is not calculated in the same way as other cylindrical shapes. The order is derived by a rule “the O ring is assembled immediately after assembling the component having the groove shape of the O ring”.

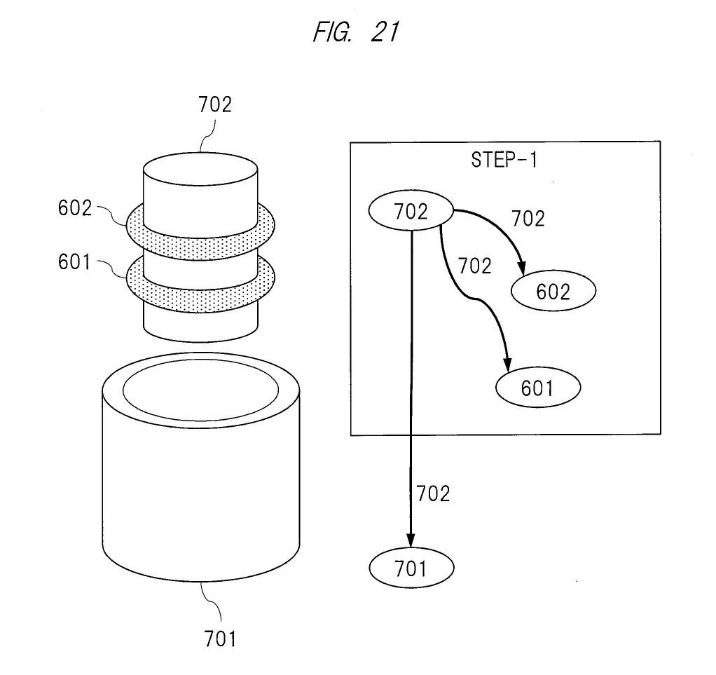

FIG. 21 is a diagram for describing an example of a determination rule of the assembling process defined individually. FIG. 21 illustrates an exemplary assembly in which a shaft component 702 is attached by two O rings 601 and 602, and inserted into a hollow component 701. Further, FIG. 21 illustrates a disassembled state where the shaft component 702 assembled with the O rings 601 and 602 is pulled upward out of the hollow component 701. In this case, as illustrated in FIG. 5, it is determined that the shaft component 702 is in the fitting relationship with respect to the O rings 601 and 602, and inserted into the cylindrical hole of the hollow component 701 by a light beam trace from the circular ring and a light beam trace from the cylindrical hole, and the connection precedence relationship is shown as the right portion of FIG. 21. At this time, the components 601 and 602 are determined as the O rings based on the classification of the component type of Step S20 of FIG. 2. In addition, the order defined by the rule of the individual definition is set to first assemble the O ring and the shaft component in Step S80 of FIG. 2.

As other rules of the individual definition, for example, in the case of a nut of the component type, the order is derived by the rule “a nut is assembled after fastening a component on an opposite side of a nut end of a component containing a screw to be fastened by the nut”. In this way, an exceptional process of the rule defined in advance is performed based on the component type and the connection relationship detected from the light beam trace.

### Generating Process of Assembly Graph

The generating process of the assembly graph of Step S90 of FIG. 2 is performed by the assembly graph generation unit 114. In the generating process of the assembly graph, based on the information of the adjacency relationship between the components of the 3D CAD model information acquired in Step S10, data indicating a relationship between the components is created by a graph in which the component is depicted by the node and the adjacency relationship is depicted by the edge (side).

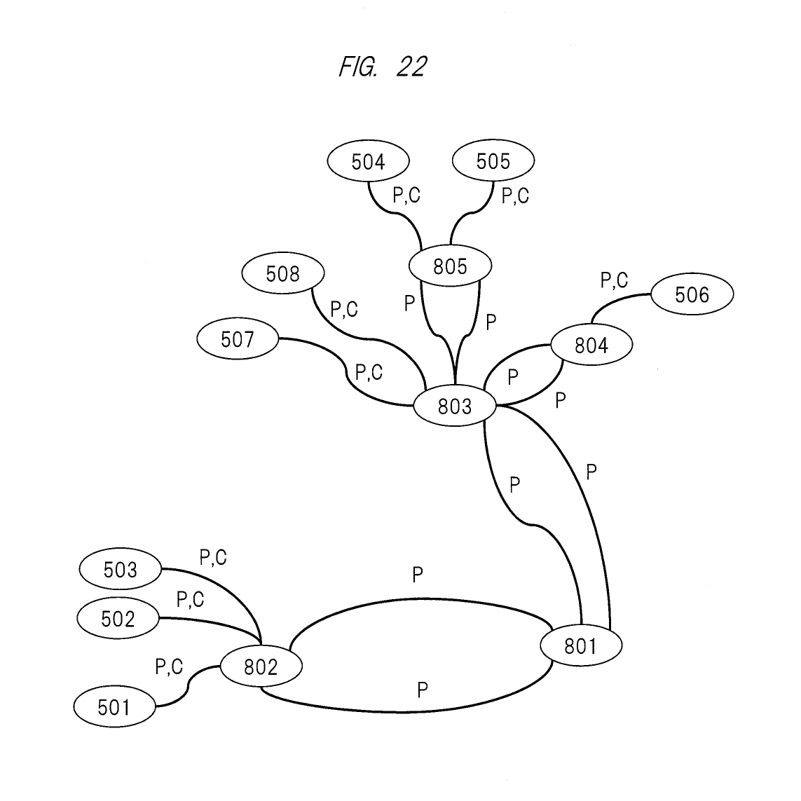

FIG. 22 is a diagram illustrating an exemplary assembly graph. FIG. 22 illustrates the exemplary assembly graph generated from the adjacency relationship between the components with respect to the 3D CAD assembly model illustrated in FIG. 11. The graph is expressed such that the component is depicted as a node and the adjacency relationship between the components is depicted as an edge, and the edge is generated for each type of the adjacency relationship (each type of the adjacent direction or the adjacent surface). In addition, the edge is roughly divided into a plane constraint (surface matching) and a cylindrical constraint (same axis), the plane constraint is denoted by P and the cylindrical constraint is denoted by C on the edge of FIG. 22. In addition, while not described in FIG. 17, similarly to the connection precedence relationship directed graph described above, in a case where the assembling directions have the same model name and the adjacency relationships are the same (the adjacent direction and the adjacent surface are the same), the subject components may be illustrated as one node even if there are a plurality of such components. The created assembly graph is stored as the assembly graph 136 in the storage unit 130.

### Generating Process of Assembling Order, Direction, Motion

The generating process of the assembling order, the direction, and the motion of Step S100 of FIG. 2 is performed by the assembling order/direction/motion generation unit 115. In the generating process of the assembling order, the direction, and the motion, the disassemble direction is generated based on the unit of disassembling and the disassembling order proposal generated in Step S70 and the assembly graph 136 generated in Step S90, and the disassembling direction and the disassembling order are generated, so that the assembling order and the assembling direction are derived by reversely converting the disassembling direction and the disassembling order. For example, by the assembling sequence generating method disclosed in Patent Document “Japanese Patent Application Laid-open Publication No. 2012-14569”, the disassemble direction is generated based on the assembly graph 136 generated in Step S90, and the disassembling direction and the disassembling order are generated, so that the assembling order and the assembling direction are derived by reversely converting the disassembling direction and the disassembling order.

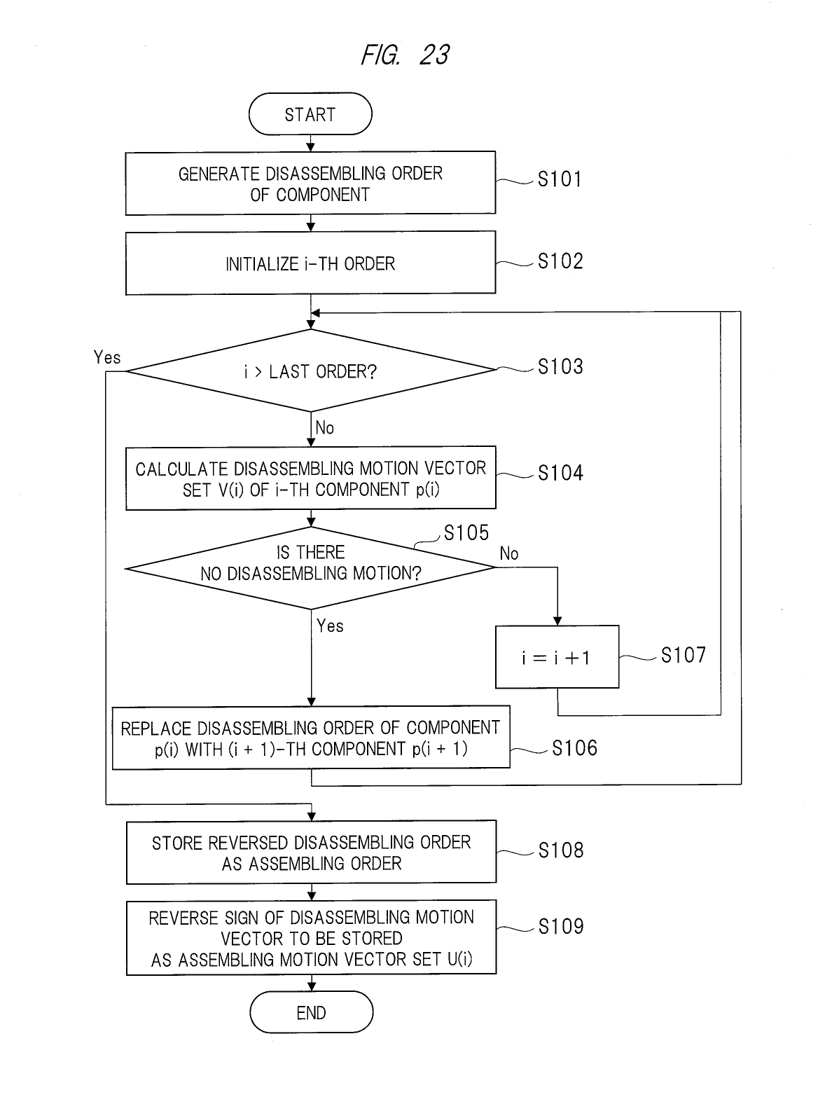

FIG. 23 is a flowchart for describing an example of a procedure of processing the deduction of a disassembling order and a disassembling motion and the conversion into an assembling order and an assembling motion.

First, in Step S101, the disassembling order proposal of the component is generated based on the assembly graph 136. Next, in Step S102, an i-th disassembling order generated in Step S101 is initialized. Then, in Step S103, it is determined whether the i-th disassembling order reaches the last of the disassembling order. In a case where the i-th disassembling order does not reach the last order (in the case of No), a disassembling motion vector set V(i) is calculated with respect to a target component p(i) of the disassembling order i in Step S104.

Next, in Step S105, it is determined whether the disassembling motion is generated (V(i)=φ). In a case where the disassembling motion is not generated due to an interference with an adjacent component (in the case of Yes), the disassembling order of the target component p(i) is replaced with the order of an (i+1)-th component p(i+1) in Step S106. That is, the order of the component p(i) is delayed to be the (i+1)-th order, and the procedure returns to Step S103. In a case where the disassembling motion is generated (No), the process proceeds to the next (i+1) order by Step S107, and the procedure returns to Step S103.

Next, in Step S103, in a case where the disassembling motion is generated up to the last of the disassembling order (in the case of Yes), the procedure proceeds to Step S108, and the reverse order of the disassembling order is stored as the assembling order. Next, in Step S109, the vector sign of the disassembling motion V(i) is reversed with respect to all the i-th assembling orders so as to store as an assembling motion vector set U(i). In this way, the data of the assembling order and the assembling motion (the assembling direction/the assembling motion) are stored as the assembling sequence data 137 in the storage unit 130.

As described above, in the generating process of the assembling order, the direction, and the motion, the disassembling order and the disassembling direction are generated based on the 3D CAD assembly model, and the sign of the disassembling motion is inverted in reverse to the disassembling order, so that the assembling order/the assembling direction is generated. As an initial proposal of the disassembling order and the unit of disassembling at this time, the result obtained from the connection precedence relationship described above is used.

Here, a plurality of proposals may be derived when the assembling order is generated. Therefore, all the processes described above are performed on these proposals. The result of the assembling sequence data 137 thus derived is output by an output process of the assembly sequence calculating result of Step S110 of FIG. 2. At this time, the 3D CAD model information 131 used in the calculation process and the generated connection precedence relationship directed graph 135 and the generated assembly graph 136 may be output together.

### Effects of Embodiments

As described above, according to the assembly order generation device 100 and the assembly order generation method of this embodiment, the connection precedence relationship between the components is automatically calculated in a state of a finished product not in the middle of disassembling based on the 3D CAD model of the three-dimensional assembly model, an assembling order proposal is derived based on the relationship figure, and a workability is evaluated based on the assembling order proposal, so that it is possible to automatically calculate the assembling order at the design stage. That is, the unit of assembling, the assembling order, and the assembling direction can be automatically derived using the three-dimensional assembly model at the design stage. As the result, a time taken for verifying an assembling performance at the design stage can be reduced, and a change in design can be reduced. More specifically, the following effects can be obtained.

(1) The assembly order generation device 100 includes the 3D CAD model information acquisition unit 111, the component type classifying unit 112, the featured shape detection unit 113, the radial/axial direction component detection unit 121, the directed graph generation unit 122, the disassembling order proposal generation unit 123, the assembly graph generation unit 114, and the assembling order/direction/motion generation unit 115.

With this configuration, in the 3D CAD model information acquisition unit 111, the information of the component attribute and the component arrangement of each of a plurality of components, and the information of the adjacency relationship with respect to the other components are extracted from the 3D CAD model of the assembly acquired from the CAD. In addition, the component type classifying unit 112 classifies the component types based on the information of the 3D CAD model. In addition, the featured shape detection unit 113 detects the designated featured shape based on the 3D CAD model.

Then, the radial/axial direction component detection unit 121 detects a component existing in the radial direction of the featured shape detected by the featured shape detection unit 113, and a component existing in the axial direction of the subject component in the 3D CAD model. Further, the directed graph generation unit 122 expresses the connection precedence relationship by the directed graph in which the component is depicted by the node and the connection precedence relationship between the components is depicted by the directed edge based on the detection result of the radial/axial direction component detection unit 121. Furthermore, the disassembling order proposal generation unit 123 generates the unit of disassembling and the disassembling order proposal based on the connection precedence relationship of the directed graph generation unit 122. In addition, the assembly graph generation unit 114 expresses the relationship between the components by the assembly graph in which the component is depicted by the node and the adjacency relationship is depicted by an edge based on the information of the adjacency relationship between the components of the 3D CAD model.

Then, the assembling order/direction/motion generation unit 115 can generate a disassemble direction to generate a disassembling direction and a disassembling order based on a unit of disassembling and a disassembling order proposal generated by the disassembling order proposal generation unit 123, and the assembly graph of the assembly graph generation unit 114, and can derive an assembling order and an assembling direction by reversely converting the disassembling direction and the disassembling order thus generated.

(2) The directed graph generation unit 122 can generate the directed graph of the connection precedence relationship in which the component is depicted by the node and the connection precedence relationship between the components is depicted by the directed edge with respect to a relationship between a component and an axial component to be connected to the component based on a detection result of the component existing in the radial direction of the featured shape and the component existing in the axial direction of the subject component in the 3D CAD model.

(3) The disassembling order proposal generation unit 123 can calculate the numbers of outer edges and inner edges of each component node in the directed graph generated by the directed graph generation unit 122, can set the component node of which the calculated value is positive as a base component candidate, can divide an edge connecting the base component candidate and an edge connected to the base component candidate into different processes, and can derive a precedence relationship based on the connections of the directed edges for each divided process group. This method is effective in a case where there are a lot of components and it is necessary to separate a plurality of work processes by stages.

(4) The disassembling order proposal generation unit 123 can separate the process of the component node detected as an obstacle existing in a disassembling direction of a fastening component by the outer edge of the component node based on a detection result of a component existing in a disassembling direction of a fastening component. This method is effective in a case where the assembling process is generated in consideration of the order of the obstacle components existing in the disassembling direction.

(5) The disassembling order proposal generation unit 123 can define a process based on a rule which is previously defined for a specified component type. This method is effective in a case where the determination is not possible based on the connection precedence relationship obtained by the light beam scan. Even in this case, the unit of disassembling and the disassembling order can be derived according to the predefined rule.

### Limited Examples of Embodiment

In this embodiment, an assembly order generation device and an assembly order generation method in which the featured shape is limited to the cylindrical hole have the following features.

(11) An assembly order generation device of a limited example of this embodiment is a generation device which generates information of an assembling order for assembling a plurality of components composing an assembly using a computer. The assembly order generation device includes an information acquisition unit which extracts information of a component attribute, a component arrangement, and an adjacency relationship with respect to the other components of each of the plurality of components from a 3D CAD model of the assembly acquired from a CAD, a component type classifying unit which classifies a component type based on the information of the 3D CAD model, and a featured shape detection unit that detects a cylindrical hole from the 3D CAD model. Further, the assembly order generation device includes a component detection unit which detects a component existing in the cylindrical hole detected by the featured shape detection unit and a distance thereof in the 3D CAD model, a directed graph generation unit which expresses a connection precedence relationship between the components by a directed graph based on a relationship between the cylindrical hole and the component in the cylindrical hole, and a disassembling order proposal generation unit which predicts a disassembling direction based on a component type and a component shape of the component existing in the cylindrical hole to detect the component existing in the disassembling direction and the distance. Furthermore, the assembly order generation device includes an assembly graph generation unit which expresses an adjacency relationship between the components by an assembly graph in which the component is depicted by the node and an adjacency relationship is depicted by an edge based on information of an adjacency relationship between the components of the 3D CAD model, and an assembling order generation unit which generates a unit of disassembling and a disassembling order based on the directed graph of the connection precedence relationship, generates a disassembling direction in the disassembling order based on the assembly graph, and reversely converts the generated unit of disassembling, the generated disassembling order, and the generated disassembling direction to derive an assembling order and an assembling direction.

(12) An assembly order generation method of a limited example of this embodiment is a generation method of generating information of an assembling order for assembling a plurality of components composing an assembly using a computer. The assembly order generation method, as process steps performed by the computer, performed by the computer includes an information acquisition step of extracting information of a component attribute, a component arrangement, and an adjacency relationship with respect to the other components of each of the plurality of components from a 3D CAD model of the assembly acquired from a CAD, a component type classification step of classifying a component type based on the information of the 3D CAD model, and a featured shape detection step of detecting a cylindrical hole from the 3D CAD model. Further, the assembly order generation method includes a component detection step of detecting a component existing in the cylindrical hole detected in the featured shape detection step and a distance thereof in the 3D CAD model, a directed graph generation step of expressing a connection precedence relationship between the components by a directed graph based on a relationship between the cylindrical hole and the component in the cylindrical hole, and a disassembling order proposal generation step of predicting a disassembling direction based on a component type and a component shape of the component existing in the cylindrical hole to detect the component existing in the disassembling direction and the distance. Furthermore, the assembly order generation method includes an assembly graph generation step of expressing an adjacency relationship between the components by an assembly graph in which the component is depicted by the node and an adjacency relationship is depicted by an edge based on information of an adjacency relationship between the components of the 3D CAD model, and an assembling order generation step of generating a unit of disassembling and a disassembling order based on the directed graph of the connection precedence relationship, generating a disassembling direction in the disassembling order based on the assembly graph, and reversely converting the generated unit of disassembling, the generated disassembling order, and the generated disassembling direction to derive an assembling order and an assembling direction.

Hitherto, the invention has been specifically described based on the embodiments implemented by the inventor, but the present invention is not limited to the embodiments. It is a matter of course that various modifications and changes may be made within a scope not departing from the spirit. For example, the above-described embodiments are given to describe the present invention in detail to help with understanding, and all the configurations are not necessarily contained. In addition, some configurations of a certain example may be replaced with those of the other examples, and the configurations of a certain example may be added to the other example. Further, additions, omissions, substitutions may be made on some of the configurations of the respective embodiments and the respective examples with other configurations.

In addition, some or all of the respective configurations, the functions, the processing units, and the processing means may be realized by hardware (for example, an integrated circuit). In addition, the respective configurations and the functions may be realized by software by analyzing and executing a program which realizes the respective functions of the processes. The information of the program realizing the respective functions, the tables, and the files may be stored in a recording device such as a memory, a hard disk, or an SSD (Solid State Drive), or a recording medium such as an IC card, an SD card, or a DVD.

### REFERENCE SIGNS LIST

100 assembly order generation device
110 control unit
111 3D CAD model information acquisition unit
112 component type classifying unit
113 featured shape detection unit
114 assembly graph generation unit
115 assembling order/direction/motion generation unit
120 connection precedence relationship generation unit
121 radial/axial direction component detection unit
122 directed graph generation unit
123 disassembling order proposal generation unit
130 storage unit
131 3D CAD model information
132 component type information
133 analysis calculation program/calculation condition
134 disassembling order condition/disassembling unit condition
135 connection precedence relationship directed graph
136 assembly graph
137 assembling sequence data
140 input unit
150 display unit
160 communication unit
200 3D CAD device
210 network

1. A generation device that generates information of an assembling order for assembling a plurality of components composing an assembly using a computer, comprising:
an information acquisition unit that extracts information of a component attribute, a component arrangement, and an adjacency relationship with respect to the other components of each of the plurality of components from a 3D CAD model of the assembly acquired from a CAD;
a component type classifying unit that classifies a component type based on the information of the 3D CAD model;
a featured shape detection unit that detects a designated featured shape from the 3D CAD model;
a component detection unit that detects a component existing in a radial direction of the featured shape detected by the featured shape detection unit and a component existing in an axial direction of the subject component in the 3D CAD model;
a directed graph generation unit that expresses a connection precedence relationship by a directed graph in which the component is depicted by a node and a connection precedence relationship between the components is depicted by a directed edge based on a detection result of the component detection unit;
a disassembling order proposal generation unit that generates a unit of disassembling and a disassembling order proposal based on the connection precedence relationship of the directed graph generation unit;
an assembly graph generation unit that expresses a relationship between the components by an assembly graph in which the component is depicted by a node and an adjacency relationship is depicted by an edge based on information of an adjacency relationship between the components of the 3D CAD model; and
an assembling order generation unit that generates a disassemble direction based on the unit of disassembling and the disassembling order proposal generated by the disassembling order proposal generation unit and the assembly graph of the assembly graph generation unit to generate a disassembling direction and a disassembling order, and reversely converts the generated disassembling direction and the generated disassembling order to derive an assembling order and an assembling direction.

2. The assembly order generation device according to claim 1,
wherein the directed graph generation unit generates the directed graph of the connection precedence relationship in which the component is depicted by the node and the connection precedence relationship between the components is depicted by the directed edge with respect to a relationship between a component and an axial component to be connected to the component based on a detection result of the component existing in the radial direction of the featured shape and the component existing in the axial direction of the subject component in the 3D CAD model.

3. The assembly order generation device according to claim 2,
wherein the directed graph generation unit generates the directed graph of the connection precedence relationship in which the component is depicted as the node and the connection precedence relationship between the components is depicted by the directed edge with respect to the relationship between the component and the axial component to be connected to the component based on the detection result of the component existing in the radial direction of the featured shape and the component existing in the axial direction of the subject component in the 3D CAD model, and
wherein the disassembling order proposal generation unit calculates the numbers of outer edges and inner edges of each component node in the directed graph generated by the directed graph generation unit, sets the component node of which the calculated value is positive as a base component candidate, divides an edge connecting the base component candidate and an edge connected to the base component candidate into difference processes, and derives a precedence relationship based on the connections of the directed edges for each divided process group.

4. The assembly order generation device according to claim 3,
wherein the disassembling order proposal generation unit separates the process of the component node detected as an obstacle existing in a disassembling direction of a fastening component by the outer edge of the component node based on a detection result of the component existing in the disassembling direction of the fastening component.

5. The assembly order generation device according to claim 3,
wherein the disassembling order proposal generation unit defines the process based on a rule which is previously defined for a specific component type.

6. A generation method of generating information of an assembling order for assembling a plurality of components composing an assembly using a computer, as process steps performed by the computer, the method comprising:
an information acquisition step of extracting information of a component attribute, a component arrangement, and an adjacency relationship with respect to the other components of each of the plurality of components from a 3D CAD model of the assembly acquired from a CAD;
a component type classification step of classifying a component type based on the information of the 3D CAD model;
a featured shape detection step of detecting a designated featured shape from the 3D CAD model;
a component detection step of detecting a component existing in a radial direction of the featured shape detected in the featured shape detection step and a component existing in an axial direction of the subject component in the 3D CAD model;
a directed graph generation step of expressing a connection precedence relationship by a directed graph in which the component is depicted by a node and a connection precedence relationship between the components is depicted by a directed edge based on a detection result of the component detection step;
a disassembling order proposal generation step of generating a unit of disassembling and a disassembling order proposal based on the connection precedence relationship of the directed graph generation step;
an assembly graph generation step of expressing a relationship between the components by an assembly graph in which the component is depicted by the node and an adjacency relationship is depicted by an edge based on information of an adjacency relationship between the components of the 3D CAD model; and
an assembling order generation step of generating a disassemble direction based on the unit of disassembling and the disassembling order proposal generated in the disassembling order proposal generation step and the assembly graph of the assembly graph generation step to generate a disassembling direction and a disassembling order, and of reversely converting the generated disassembling direction and the generated disassembling order to derive an assembling order and an assembling direction.

7. The assembly order generation method according to claim 6,
wherein in the directed graph generation step, the directed graph of the connection precedence relationship is generated in which the component is depicted by the node and the connection precedence relationship between the components is depicted by the directed edge with respect to a relationship between a component and an axial component to be connected to the component based on a detection result of the component existing in the radial direction of the featured shape and the component existing in the axial direction of the subject component in the 3D CAD model.

8. The assembly order generation method according to claim 7,
wherein in the directed graph generation step, the directed graph of the connection precedence relationship is generated in which the component is depicted as the node and the connection precedence relationship between the components is depicted by the directed edge with respect to the relationship between the component and the axial component to be connected to the component based on the detection result of the component existing in the radial direction of the featured shape and the component existing in the axial direction of the subject component in the 3D CAD model, and
wherein in the disassembling order proposal generation step, the number of outer edges and inner edges of each component node in the directed graph generated in the directed graph generation step is calculated, the component node of which the calculated value is positive is set as a base component candidate, an edge connecting the base component candidate and an edge connected to the base component candidate are divided into difference processes, and a precedence relationship is derived based on the connections of the directed edges for each divided process group.

9. The assembly order generation method according to claim 8,
wherein in the disassembling order proposal generation step, the process of the component node detected as an obstacle existing in a disassembling direction of a fastening component is separated by the outer edge of the component node based on a detection result of the component existing in the disassembling direction of the fastening component.

10. The assembly order generation method according to claim 8,
wherein in the disassembling order proposal generation step, the process is defined based on a rule which is previously defined for a specific component type.
